(19) United States
(12) Patent Application Publication
(10) Pub. No.: US 2015/0371258 A1
(43) Pub. Date: Dec. 24, 2015

(54) METHODS, PRODUCTS AND SYSTEMS FOR MANAGING INFORMATION

(71) Applicant: ROBERT BRAMUCCI, Ile Bizard (CA)

(72) Inventor: ROBERT BRAMUCCI, Ile Bizard (CA)

(21) Appl. No.: 14/189,930

(22) Filed: Feb. 25, 2014

Related U.S. Application Data
(60) Provisional application No. 61/769,111, filed on Feb. 25, 2013.

(51) Int. Cl. G06Q 30/02; H04L 29/08

(52) U.S. Cl. CPC G06Q 30/0246; H04L 67/22; G06Q 30/0257

(57) ABSTRACT

Methods, products and systems for managing information comprise a computer-based information warehouse comprising information files provided to a user on-demand. Each information file is assigned a unique identification (ID) code. Entry of ID code into code input device results in automatic execution of corresponding information file from the information warehouse to a computer in communication with both input device and information warehouse. A function menu enables user-selection of one or more options relating to said information file. Methods, media and systems for monitoring activity relating to each file of the information warehouse.

### RELATED APPLICATION DATA

This application claims priority of U.S. Provisional Patent Application No. 61/769,111 filed Feb. 25, 2013, which application is herein incorporated by reference.

### BACKGROUND OF THE INVENTION

1. Technical Field

The present disclosure relates generally to methods, media and systems for managing and distributing information, and more particularly, to computer-based methods, media and systems for managing and distributing information.

2. Background Information

Information is present in our lives in an abundant supply. The information might relate to our personal lives such as information relating to friends and family, one's education history/record, one's medical history/record, employment history, financial records. The information might relate to our businesses such as advertising, marketing, research information, portfolios, and the like. Regardless of the type of information, virtually every aspect of our lives comprises a volume of it. Managing this information can be improved upon, and methods, apparatus, and systems for managing information are of use for the private sector and the public sector as well.

One example of information present in an over-abundant supply is advertising and marketing information. Consumers are bombarded by advertisements (“ads”) on a daily basis yet the majority of the ads have little to no relevance to the consumers who receive them. From the consumer's perspective, advertising is generally perceived as bothersome and intrusive and thus consumers often dislike and/or ignore the ads. From the advertiser/marketer's perspective, a large amount of resources (e.g., time and money) are placed on advertising in hopes of stimulating consumer interest in and desire for the advertised products. The advertiser/marketer's main goal being to increase sales and profit from the advertised products. Unfortunately, advertisers/marketers generally do not know who sees their advertisements, and/or whether the ads influence consumers and/or sales of the products therein.

With the increasingly widespread use of computer-based technology including but not limited to computers, the Internet, mobile phones, and handheld computer devices, advertising and marketing media has expanded to include not only hard-copy printed material for example but not limited to newspapers and magazines, and “traditional” electronic media for example, but not limited to, television and radio, but also electronic and computer-based media including but not limited to the World Wide Web (“Web”), mobile phones, interactive touchscreens, and interactive three dimensional displays/images. As a result, many marketers, advertisers, publishers, businesses and the like now have Web sites comprising goods and services, and/or online purchasing for their goods and services available to consumers.

The dissemination of information, goods and services via the Web and other computer-based and computer-related technology is not without drawbacks. For example, while browsing/surfing the Web, a user is again bombarded by information, numerous ads and pop-ups and, similar to the situation with television, radio and hard-copy print media, much of the information and ads are perceived as annoying and are irrelevant to his needs. With respect to information, advertised products, and/or services that are of interest to a user, these are often troublesome to track down and obtain on the Web. For example, assuming an individual has knowledge of a business's Web address, the individual generally must go through a number of steps in order to arrive at the Web site, followed by further steps to arrive at the desired information or product. Generally an individual must manually enter the Web address in his Web browser and then, upon arriving at the desired Web site, generally he must navigate his way around/through the site in order to locate the information of interest. This is by no means a simple task as often times Web sites are cumbersome or difficult to navigate, and/or have an abundance of items and information, which may or may not be presented in a clear fashion. For the average individual with a busy lifestyle, and especially those individuals with minimal Web browsing skills, any one or more of these steps may be daunting enough endeavors to cause him to lose interest.

With respect to accessing Web sites and Web pages, changes have been made directed at simplifying the process. For example, U.S. Pat. No. 6,745,234, issued Jun. 1, 2004, to Philyaw and Mathews teaches a method for controlling a computer wherein one or more remote locations disposed on a network are accessed in response to scanning an optical code. A first computer disposed on the network connects to a scanner for scanning the optical code of a product by a user. The scanner is uniquely identified with a scanner distributor by a scanner identification number. A second computer disposed on the network is accessed in response to the user scanning the optical code with the scanner, wherein a lookup operation is performed at the second computer to match the scanner identification number with the scanner distributor to obtain remote routing information of the one or remote locations. The remote routing information is returned from the second computer to the first computer in order to access the one or more remote locations disposed on the network. The one or more remote locations are accessed to return remote information to the first computer for presentation.

U.S. Pat. No. 6,505,776 issued Jan. 14, 2003, to Wiley et al, teaches a body-wearable bar code symbol driven system for accessing information resources from information servers connected to communication networks, including the Internet. The body-wearable system includes a hand-mounted bar code symbol reader for reading bar code symbols encoded with information representative of information resources stored in information servers connected to the Internet and supporting the TCP/IP standard. A computing platform, worn on the body of the operator, is provided for supporting an Internet browser. A telecommunication modem is operably connected to the computing platform in order to establish a two-way telecommunication link between the Internet browser and an Internet service provider (ISP) connected to the Internet. In response to reading bar code symbols, the Internet browser automatically accesses information resources from Internet information servers using the information encoded in bar code symbols read by the bar code symbol reader. A display panel is provided for visually displaying information resources accessed from the Internet information servers by the bar code symbol driven Internet browser.

U.S. Patent Application Publication No. US 2006/0124742 A1, published Jun. 15, 2006, to Rines et al, discloses methods and apparatus for accessing Web sites. The methods of Rines allow a reader of a publication that is associated with a particular publisher Website to access supplemental material contained on the publisher's Web site relevant to a particular passage in the publication by scanning a barcode for the passage. By using a scanner to scan the barcode at a relevant passage in the publication, a Web browser in communication with the scanner is directed to the particular Web page corresponding to the particular barcode.

Despite advances in the field, there remains a need for methods, media and systems for information management.

There are adverting metrics proposed for online advertising. These metrics will determine the value of the advertising, the corresponding advertising rate, and could even influence how advertising is developed.

Specifically, the Interactive Advertising Bureau (IAB) is comprised of more than 500 leading media and technology companies that are responsible for selling 86% of online advertising in the United States. On behalf of its members, the IAB is dedicated to the growth of the interactive advertising marketplace, of imperative's share of total marketing spend, and of its members' share of total marketing spend. The IAB educates marketers, agencies, media companies and the wider business community about the value of interactive advertising. Working with its member companies, the IAB evaluates and recommends standards and practices and fields critical research on interactive advertising.

The IAB has a number of core objectives, including to coalesce around market-making measurement guidelines and creative standards.

Referring now to FIG. 4, there is provided a schematic representation of the prior art IAB digital measurement scheme, with comments provided by applicant. Simply stated the IAB guidelines are based on the simple premise that the “measurement” correlates to the “opportunity to see”.

An “Impression” is a measurement of responses from a Web server to a page request from the user browser, which is filtered from robotic activity and error codes and is recorded at a point as close as possible to opportunity to see the page by the user.

A “View” is often used as a synonym for “Impression”. Any measurement and reporting of a “View” should be governed by the “Impression” definition above.

A “Viewer” is a person viewing content or ads on the Web. While very desired, in the current state of the art, there is currently no way to measure viewers.

It is a general consensus that the online advertising industry is very good at measuring “how many?” in the form of ad serving reports that are focused on audience delivery and on direct response metrics, such as click through, without any consideration of the long-term branding impacts on the advertisers' targets.

In fact, “[t]ry as it might, the ad industry has not come up with a good way to compare the relative value of impressions from medium to medium, leaving those responsible for ad spending very largely in the dark.” “Three Screen Measurement” (Nielson),

The problem with current technologies, is that all measurements on the internet are based on page views and impressions. The IAB defines impressions as an opportunity to see. There is no technology at this time to measure a user's “ad viewing time” on the internet.

Another problem with current technologies, is that data reports are designed by analysts for analysts and not for immediate use by marketers and advertisers. Many times, advertising decisions are based on analysts interpretation of data post campaign, and this means that advertisers reaction time is often too late to take advantage of or mitigate a situation.

Another issue, is that data is collected in “silos”: Advertisers must sift through information from a variety of sources like YouTube, Google Analytics, Nielsen, the social TV analytics firm Bluefin, Oracle's social conversation analysis company Collective intellect, geospatial data management and visualization firm GeoIQ, as well as online survey research and proprietary platforms.

And even more recently, the Search Engine Journal, Apr. 18, 2012 http://www.searchenginejournal.com/google-brand-activate/42702/, reported Google announced new online advertising metrics. Specifically, Google announced the new ‘Brand Activate’ advertising program, which will provide brands with useful metrics related to quantifying the benefits of online ad campaigns. It is noted that Google is hopeful that the new Brand Activate program will entice marketers to reallocate money from traditional advertising methods to online advertising. The Journal notes that although Google sells an impressive $38 billion of advertising annually, big brands are currently spending over $190 billion per year on television advertisements.” The Journal further reports that The Brand Activate program is initially focused on providing Active View and Active GRP metrics to the advertisers. The Journal further reports that Active View, which Google hopes will become the new standard for online ad impressions, measures if the ad was seen by the user, the percentage of the ad that was seen, and the duration of ad exposure. Google will only count the ad as “viewed” if the advertisement was “at least 50% viewable on the screen for at least one second.” In hopes of standardizing online advertising terminology, Google has submitted its definition of a viewed ad to the Media Rating Council. In addition to Active View, Google also revealed Active GRP, which is similar to the Gross Rating Point metric used by the television industry. However, since the metrics are delivered in real-time, Active GRP will allow advertisers to quickly measure the effectiveness of a campaign and adjust accordingly. Active GRP focuses on providing information related to the reach and frequency of the digital campaign. It is thought that the new program will provide brands with better advertising metrics and measurements. An internet advertising provider stated that it thinks that a new generation of measurement solutions will help brands quantify the benefits of investing online and will help to fund the next generation of great online content and services. This ad provider further notes this is a new effort to re-imagine online measurement for brand marketers and—crucially—to help brands turn measurement into action, immediately. This ad provider has stated that the new program is currently being tested on certain of its customers and is being used for traditional display, video, and mobile. They plan to expand the program in the near future.

The current industry approach is still based on impressions, client/browser-initiated and page view with “opportunity to see”: half the ad in the screen's viewing area for 1 second is considered a viewable impression This does not help brand advertising, within a page view there can be multiple ads, there is currently no way to determine exactly what the viewer is looking at and guarantee that a specific ad was viewed.

In addition, the IAB Broadband Committee and Measurement Task Force recognize that capturing initiation of a broadband video commercial, end-point and duration data could enable buyers and sellers to understand the final behavior of consumers (end-users). Current technologies do not readily permit this.

Ad Age Digital, published Sep. 20, 2010, S. Mane, “Why Measurement Is Still Screwing Up the Online Ad Business”, discloses a number deficiencies with current online advertising measurement schemes. “[D]igital media measurement is a mess, and we're all responsible for it. There are multiple vendors producing ever-growing quantities of data that often do not agree with each other even directionally. There is no ‘currency’ that governs the planning, buying and delivery of guaranteed audiences for advertising flights. What's more, as an industry we have contributed and created the faulty perception that online advertising is not brand hospitable because of the way we have allowed online advertising to be evaluated and bought on direct response metrics like clicks and actions. For too long, we as an industry have fueled the problem and done little to suggest solutions. As a result, it has created a complex and costly supply chain and compromised the ability of marketers, ad agencies and publishers to be accountable for advertising expenditures . . . It is time for the entire ecosystem to take control of measurement. That includes defining and using metrics that matter—metrics that take us from counting exposures to valuing exposures to contributing to brand health to putting paid and earned media together in creative cross platform campaigns—and providing easy to use post-buy analyses. Yes, you just read that long bombastic sentence. And you will read it again because it captures the dire needs we have today. They will be exacerbated if we do not solve them now Blog post Sep. 20, 2010.

What advertisers are saying about digital measurement.—Taken from articles published in Advertising Age, here their comments illustrate the present situation.

Frankly, we're frustrated with the industry's inability to advance measurement practices. We must give marketers the data, facts and information to make better marketing decisions. In collaboration with the 4A's, IAB and other industry partners, the ANA is determined to advance digital-advertising measurement and cross-platform analytics. Collaboratively, we have made major strides over the past 18 months. One of the most important developments was the creation of the new standard, the “viewable impression”. This will replace the archaic “served impression,” a source of grossly misleading and overstated metrics. An advertising association president, Nov. 25, 2012

The newer social and niche networks are quick to adopt traditional brand impression delivery metrics abandoning their response-based roots because, mistakenly, they believe they can monetize their audience better with CPM sales versus performance-based sales. This thinking is stunningly wrong given the results of this new Adobe study, The State of Online Advertising. It should be a wake-up call to the online ad network world because it starkly lays out how online marketing is failing with consumers. “If marketers can't get actionable audience delivery information, (e.g. better metrics on real audiences numbers versus targeted impression metrics), then relevancy and results will be hit or miss. Everyone loses. “Impressions don't buy, real people do.” A chief brand strategist, Nov. 5, 2012

Mass of Metrics May Mean Marketers Know Less. “In a classic case of more not necessarily being better, the rise of digital and social media has spawned a host of new metrics and measurement systems. Whether marketers really know more as a result is more doubtful, however, giving rise to efforts to validate which metrics are really worthwhile. To be sure, there's growing recognition that the industry's bounty of metrics hasn't necessarily made marketing better. ‘What's making everything much more murky is the amount of data that's available today,’ said a media consultant. ‘It just blows the mind. It's very hard to think constructively about media planning when you have 500 different research sources telling you what's going on, because you can prove anything you want. We need to get back to a simple set of measurements that in fact identify response. A fundamental problem across all metrics is setting for what actually can be measured rather than measuring what actually contributes to the ultimate goal: sales.” AdAge.com. Sep. 20, 2010

‘Viewable’ Ads Are Worthless If Your Website Is a Cluttered Mess. Many of today's pages are a hot mess of links, content, graphics, skins unrequested video and floating banners. They are an assault on the senses, and one in particular—our vision—does some quick filtering to skip through the obstacles and find what we came for. If the cognitive dissonance is too strong, we're gone. The ads we skipped counted as viewable, but we never noticed them. Without the addition of page-quality data, viewability will never give advertisers what they really want: a measure of how well their ads stood out. A viewability metric that includes page-quality data also aids publishers, by giving them a way to improve the quality of their pages—the layout, the ad quantity, the type of ad that works best—so they can attract better advertisers and better readers alike. When engagement goes up, and pages and audiences become more valuable, the ecosystem improves for everyone. Clutter isn't just the advertising, it's everything—the entire environment of a page. An industry CEO. Nov. 19, 2012

A major internet social media company CEO recently said: “Our business is only going to work if we're putting content in front of our users that they want to see and that they engage with. And that's the simple equation. If we do that, the users will be happy, our business will work, and our advertisers win.” If we're going to forge ahead and make branded content work for brands, publishers, and consumers, we need to fill in what's missing. Whether it's native, custom, sponsored, premium, or scalable, we need to explore new ways to get all of this amazing content we're creating surfaced, seen, and discovered in the digital stream. After all, investing in assets that just lie dormant in a forgotten banner ad would be a waste. AdvertisingAge, Nov. 21, 2012.

“HOW CAN WE REGAIN CONSUMERS' TRUST?” The way we now target and reach consumers is great for scale, but it's also created Chaos and Unease. By giving consumers choices (“pull” rather than “push” technology) trust goes up and so do the chances for efficient marketing ROI. It's time to pivot the free-platform debate into a practical discussion of how marketing-technology platforms (free or paid) can support the urgent, emerging need for trust-marketing innovation. A chief brand adviser. Advertising Age, Jul. 24, 2012

Gatorade's Mission Control—the PepsiCo brand's physical space dedicated to monitoring and engaging in social media—“was prompted by this feeling that we were just too far removed from the data and our reaction time was too late,” he said. For now, “It's more about having a collection of people reviewing data in-house and entering into the conversation. We tend to measure what we can count rather than measuring what really matters, he said. “We need to measure how people are becoming involved in brands, how people are advocating on behalf of brands. We're figuring out ways to synthesize the data we have,” he said, noting Pepsi looks at information from a variety of sources like YouTube, Google Analytics, Nielsen, social TV analytics firm Bluefin, Oracle's social conversation analysis company Collective intellect, geospatial data management and visualization firm GeoIQ, as well as online survey research and proprietary platforms. AdvertisingAge, Nov. 14, 2012

Today's impressions are counted when they leave an ad server. The proposal on the table from the Making Measurement Make Sense initiative, is to move from impressions served to impressions actually seen by consumers. Members of this initiative—the boards of directors of the association of National Advertisers, the American Association of Advertising Agencies and the Interactive Advertising Bureau—had a summit in Chicago to discuss critical issues facing the digital-advertising industry. There I heard the demand for viewable impressions loud and clear from the most influential leaders across the marketplace. When advertisers know their ads are visible, when they see a rise in performance, when we have a conversation based on the reality that there is a finite amount of valuable advertising space online, and when we are able to make apples-to-apples comparisons with other media that rely on viewability measures, advertiser confidence in buying display ads increases. They buy more. Businesses that choose not to measure up risk a painful fate. Industry executive, Sep. 27, 2012

In practice, advertisers want sites to guarantee “dwell time” or the seconds a person is exposed to a given brand and monitor their actions. Advertisers would pay sites by total time of unique exposure (time of advertiser brand exposure) rather than how many impressions were served.

Analytic companies deal with the number of people or readership, and survey consumers on measures such as ad-recall and actions taken in response. This methodology requires a representative selection of sample respondents, focused questionnaires, and deductive interpretations of the responses.

There clearly is a need in the art for methods, products, and apparatus relating to digital advertising and measurement data.

Thus, there is a need in the art for methods, media and systems that provide a user with on-demand information.

There is another need in the art for methods, media and systems that monitor activity relating to computer files.

There is even another need in the art for methods, media and systems that enable a user to obtain information via the Internet without the need to view, navigate and/or search a Website or Webpage.

There is still another need in the art for methods, media and systems that provide on-demand advertising and marketing to a consumer.

There is yet another need in the art for methods, media and systems that allow an advertiser/marketer to monitor and track activity relating to any one or more advertisement and/or product.

There is even still another need in the art for methods, media and systems that enable a business, for example a publisher, to complement it's hard copy/print media products with Web-based/soft copy media.

There is another need in the art for methods, media and systems that provide Time Based Measurement of consumer ad viewings for both still ads and video ads

There is another need in the art for methods, media and systems that measure consumer ad viewing time from in point to end-point that provides exact duration data in seconds, an equalizing metric common to all media.

There is another need in the art for methods, media and systems that measure the overall time an audience is exposed to a given brand's ads in exact seconds.

There is another need in the art for methods, media and systems that provide measurement of advertising effectiveness rather than just ad delivery time.

There is another need in the art for methods, media and systems that allow comparison of Internet advertising to television advertising in a way acceptable to TV ad buyers. Analyzing the total time of exposure per person to both online units and TV units allow the use of seconds of delivery (something that all media have in common) rather than impressions.

There is another need in the art for methods, media and systems that allow Time Based Measurement to better equip advertisers to make decisions about how to connect with consumers across all the available platforms. In this way they can achieve the greatest results, better optimize their campaigns in-flight, and analyze the outcomes in qualitative and quantitative terms

There is another need in the art for methods, media and systems that allow for delivery of Anytime Anywhere Media Measurement (A2/M2).

There is another need in the art for methods, media and systems that provide for a “one source metric system”. A system that tracks and measures across all media both digital online media and traditional off line media, and can present detailed performance data for immediate comparisons.

There is another need in the art for methods, media and systems that provide a “one source metric system” that track and measure ad performance as a total of all linked-media used in a campaign, with the ability to compare results media by media, segment audience by segment audience, to capitalize on the unique benefits of each media while also showing how individual media combine to provide broad based delivery.

There is another need in the art for methods, media and systems that track the percentage of total impressions that result in an action taken.

There is another need in the art for methods, media and systems that shift advertiser attention from the delivery of the specific unit to the quality of the overall campaign delivery.

These and other needs in the art will become apparent to those of skill in the art upon review of this specification, including its drawings and claims.

### SUMMARY OF THE INVENTION

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided a computer-implemented method for managing information comprising the steps of: a) entering identification code data in a first computer, wherein the identification code data is unique to a computer file maintained in a file system on a second computer, wherein the file system comprises a multitude of files each having a unique identification code assigned thereto; b) communicating the code data via the Internet to a second computer; c) retrieving the computer file unique to the code data; d) executing the computer file on the second computer; and e) displaying step d) via the Internet on a display device in communication with the first computer. Generally steps b), c), d) and e) take place automatically as a result of step a). The method may further comprise the step of: f) executing on the second computer a menu file comprising a list of user options which are displayed via the Internet on the display device. Generally step f) takes place automatically after step e). The method may further comprise the step of: g) maintaining in one or more event tracking databases event data relating to any one or more of steps a), b), c), d), e), and f). Generally the one or more databases are maintained on the second computer, and step g) takes place automatically after each of steps a), b), c), d), e), and f). The method may further comprise the step of h) requesting event data from said one or more event tracking databases.

According to another non-limiting embodiment there is provided an information handling system comprising: a processor; memory accessible by the processor and having stored therein a plurality of files, wherein each of the plurality of files is uniquely associated with identification code data that when received from a user's computer causes the system to execute the file associated with the code data and display file information as instructed by the file.

According to even another embodiment there is provided a system for managing information comprising: a processor; memory accessible by the processor and having stored therein a plurality of files, wherein each of the plurality of files is uniquely associated with identification code data; and a print media product comprising one or more printed portions, each portion comprising a unique identification code, uniquely associated with one of the plurality of files, each code comprising identification code data, and wherein the identification code when received from a user's computer causes the system to execute the file associated with the code and display file information as instructed by the file.

According to still another embodiment there is provided an information handling system readable medium having stored thereon a set of instructions that when executed on an information handling system, instruct the information handling system to: receive identification code data from a first computer, wherein the identification code data is unique to a computer file maintained in a file system on the information handling system, wherein the file system comprises a multitude of files each having a unique identification code assigned thereto, and wherein in response to receiving the identification code data the information handling system is further instructed to execute the file unique to the code data and display file information as instructed by the file. The set of instructions may further instruct the information handling system to execute a menu file and display information as instructed by the menu file. The set of instructions may further instruct the information handling system to maintain in one or more event tracking databases event data relating to one or more of the receiving code data, executing the file, displaying file information, and executing the menu file.

According to yet another embodiment there is provided a print media product comprising one or more printed portions, each portion comprising a unique identification code, each code comprising identification code data uniquely associated with a computer file maintained in a file system maintained on a first computer, and wherein the identification code data when entered into a second computer is communicated to the first computer causing the uniquely associated computer file to be executed on the first computer and to display file information as instructed by the file. Generally the identification code is selected from the group consisting of barcodes, alphabetic codes, numeric codes, alpha-numeric codes, binary codes and all combinations thereof. Generally the print media product is selected from the group consisting of magazines, newspapers, advertising flyers, directories, brochures, pamphlets, posters, tickets, collectible and playing cards, all types of cards, business cards, paper, books, and all combinations thereof. In one non-limiting embodiment the print media product is a magazine.

According to even yet another embodiment there is provided a method of online advertising, wherein an online advertisement comprises a link to a dedicated online product landing page. The method may include receiving a visitor onto the dedicated product landing page who has utilized that link. The method may also include measuring the duration between the time the viewer was received on the dedicated product landing page, and when the viewer clicks on a soft key. The method may also include that case wherein the link provides identifier information, and the method further comprises (C) creating a report utilizing the identifier information. The method may also include measuring the time between subsequent other soft key clicks to determine the viewing time of information accessed through the other subsequent soft key.

According to even yet still another embodiment there is provided a method of advertising, wherein one or more online advertisements each comprise its own unique link to a dedicated online product landing page, and wherein one or more offline advertisements each comprises it own unique codeword to access the dedicated product landing page. The method may include receiving a visitor onto the dedicated product landing page who has utilized the unique link or unique codeword. The method may also include measuring the duration between the time the viewer was received on the dedicated product landing page, and when the viewer clicks on a soft key. The method may also include the case wherein the unique links and unique codewords provide identifier information, and the method further comprises (C) creating a report utilizing the identifier information. The method may also include measuring the time between subsequent other soft key clicks” to determine the viewing time of information accessed through the other subsequent soft key.

According to still even another embodiment there is provided a method of advertising utilizing an application server. The method may include receiving at the application server, a video viewing request from a browser serving a user. The method may also include playing a video in response to the video viewing request. The method may also include generating statistical information about the video viewing.

Further embodiments of any method embodiments may include hardware and/or software systems for implementing such methods, computer readable products incorporating steps for such methods, downloadable versions such methods, propagated signals incorporating such methods

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a flow chart of a non-limiting method of the disclosure.

FIG. 2 is a flow chart of a non-limiting method of the disclosure.

FIG. 3 is a schematic representation of a non-limiting system of the disclosure.

FIG. 4 is a schematic representation of the prior art IAB digital measurement scheme, with comments provided by applicant.

FIG. 5 is a schematic representation showing a non-limiting embodiment of the digital advertising method of the present invention.

FIGS. 6-27 relate to a simulated fictitious advertising campaign using software of the present invention using fictitious data.

FIG. 6 shows an enabled product ad of the present invention positioned in an online newspaper, with the linked landing page shown inset.

FIG. 7 shows another example landing page for online ads.

FIG. 8 is a non-limiting example of a Home Page (screen shot).

FIGS. 9-27 relate to output generated from the software for the fictitious advertising campaign.

FIG. 9 is output generated from the software showing statistics by campaign—total of all linked media and media category.

FIG. 10 output generated from the software showing statistics by campaign—media type.

FIG. 11 output generated from the software showing statistics by campaign—by individual media.

FIG. 12 output generated from the software showing statistics by campaign—by detailed video viewing time measurement.

FIG. 13 output generated from the software showing statistics by campaign—by Region/City.

FIG. 14 output generated from the software showing statistics by campaign—Newspapers.

FIG. 15 output generated from the software showing statistics by campaign—Internet.

FIG. 16 output generated from the software showing statistics by campaign—Online newspapers.

FIG. 17 output generated from the software showing statistics by campaign—Magazine APP's.

FIG. 18 output generated from the software showing statistics by campaign—TV.

FIG. 19 output generated from the software showing statistics by campaign—Network TV.

FIG. 20 output generated from the software showing statistics by campaign—Tracks all media examples.

FIG. 21 output generated from the software showing statistics by campaign—Additional Features—top right.

FIG. 22 shows additional features of the software—brand exposure

FIG. 23 shows additional features of the software—Total population

FIG. 24 shows additional features of the software—Online GRP

FIG. 25 shows additional features of the software—Demographics

FIG. 26 output generated from the software showing statistics by campaign—mobile devices—smart phones.

FIG. 27 output generated from the software showing statistics by campaign—mobile devices—tablets

FIGS. 28-31 examples of output from prior art advertising metric systems.

### DETAILED DESCRIPTION OF THE INVENTION

The present disclosure is directed to computer based methods, media and systems for managing information. The methods, media and systems of the present disclosure provide a user with a shortcut through the Internet by enabling a user to obtain information via the Internet without having to view and/or browse a Web site, or view and/or browse a Web page. The present methods, media, and systems provide a user with on-demand access to information. Generally the information is stored in the form of a computer file and may be any type of computer file known in the art. The files are maintained in folders or directories which are part of a file system, referred to herein as the “information warehouse.” Each information file in the information warehouse of the present disclosure is assigned a unique identification code (ID code) which may be used to access and/or retrieve the information file and data relating thereto. Each ID code of the present disclosure is configured to automatically execute a set of instructions loaded/installed on a computer when the ID code is received by the computer. The set of instructions automatically directs the computer to the information warehouse which is maintained on a second computer, and accesses the information file therein corresponding to the ID code of interest. The file may then be executed and is displayed on a display device associated with the first computer. In another embodiment, the file may be downloaded to the first computer and then executed on the first computer. The present disclosure further provides methods, media and systems allowing one or more authorized individuals/parties to access and/or obtain data relating to activity with respect to information files of the disclosure. The methods, media and systems of the present disclosure are computer-based and any applicable computer technology, hardware, and programming methodologies known in the art may be utilized herein.

The present disclosure further provides methods, media and systems that enable a business, for example a publisher, to complement it's hard copy/print media products with Web-based/soft copy media. Thus, a business such as, but not limited to, a publisher is able to utilize the Internet as a part of his business instead of perceiving the Internet as a competitor or a threat to his business (i.e., hard copy/print media products).

With respect to the information files of the information warehouse of the present disclosure, the files may be any type of computer file known in the art. The files may be text, audio, graphic, animation, video files, or any combinations thereof. The information files of the present disclosure may comprise information relating to anything one might wish to catalog, organize and/or make available for access to another one or more individuals or group. Thus, the information files may comprise information relating to any one or more products available from a manufacturer, advertiser, supplier and/or business. As used herein, the manufacturer, advertiser, supplier and/or business may comprise one individual or more than one individual. The product may be any type of goods, service, and combinations thereof that may be available for purchase by a consumer. The information files may comprise information relating to the product such as but not limited to price, description of product function, product specifications, product composition, product content, history of said product, manufacturer information, photographic and/or diagrammatic representations and/or views of the product, demonstration of the product in use, testimonials of said product, and all combinations thereof.

The information files may comprise information relating to one or more individuals, or one or more groups wherein the information may be of interest to any one or more individual or group. This includes but is not limited to health information, medical information, any type of personal information, contact information, emergency information, curriculum vitaes (CVs) and/or resumes, academic/educational transcripts and information, bios, demos, portfolios, event information, and all combinations thereof.

As stated, the information may be directed to anything one might wish to catalog, organize and/or make available for access to another one or more individuals or group. The information may be directed to any field such as but not limited to fashion, beauty, health, education, learning, history, science, engineering, architecture, art, music, medicine, fitness, nutrition, automotive, entertainment, sports, lotteries, business, finance, news, polls, politics, environment, and all combinations thereof. The information files may comprise any form of media representing any one or more personality from any walk of life such as but not limited to, political figures, movie stars, artists, musicians, rock stars, sports figures, fashion models, the “man on the street”, the average person and may be directed to any group or individual including but not limited to governments and agencies thereof, non-profit organizations, individuals and industry.

Generally each information file in the information warehouse of the present disclosure is assigned a unique identification (ID) code which may be used to access, manage, and/or retrieve the file and/or information relating to the file. Generally, no two or more information files will share the same ID code at a given time. With respect to ID codes suitable for use in the methods and systems of the present disclosure, any types of indicia, codes, notation and the like known in the art and suitable for use in inventory and identification purposes may be used herein. For example, the ID code may be any type of barcode, an alphabetical code, a numeric code, an alpha-numeric code, a binary code, a graphic icon, a symbol, and any multiples, mixtures and combinations thereof. The ID codes may be generated by any one or more method known in the art for generating unique values in a system, and all are suitable for use herein.

Within the information warehouse, the files may be organized in folders and/or directories and may be organized in any manner. The owner and/or creator and/or administrator of the information warehouse may determine the manner in which the files are organized. For example, files might be organized by topic, by source, by size, chronologically according to date created or date entered into the warehouse, by code, or any combinations thereof. Methods for creating and operating file systems, folders and directories are well known to those of skill in the art and any are suitable for use herein. Generally when information is submitted for addition to the information warehouse, an information file comprising the information is created, and the file is assigned a unique ID code of the disclosure. Generally the assignments for the ID codes of the disclosure are maintained in a database useful for authenticating code input data as well as maintaining inventory of the information warehouse.

The ID codes of the present disclosure may be present in any one or more type of hard copy media and/or printed media such as but not limited to magazines, newspapers, advertising flyers, directories, brochures, pamphlets, posters, tickets, collectible and playing cards, all types of cards, business cards, paper and books. The ID codes may be present on any one or more types of label, tag or similar item that may be affixed or attached to a product, object, person, and/or animal. The ID codes may be present on any one or more types of pendant, bracelet, necklace, ring, pin, brooch, or any other jewelry and/or ornamental type of item which may be attached to and/or worn by any person, animal, object and/or article. The codes may be applied by any method known in the art including but not limited to all forms of printing, IC chips, painting, writing, stamping, engraving, embossing, and combinations thereof, which may be an automated or manual process or a combination thereof. The ID codes may be tattooed on any one or more people and/or animals. The ID codes may be displayed on a screen such as but not limited to a computer screen, a television screen, a display panel of a mobile phone, a display panel of a wireless handheld device. The ID codes may be present and/or displayed in any one or more of the aforementioned methods and may be displayed directly, or may be embedded/encrypted within an advertisement, or a combination thereof.

According to one non-limiting embodiment, the ID code is present on one or more types of hard copy print media as part of an advertisement for a corresponding product referenced therein. As previously stated, hard copy print media includes but is not limited to magazines, newspapers, advertising flyers, directories, brochures, pamphlets, posters, tickets, collectible and playing cards, all types of cards, business cards, paper and books. The advertisement may be any type of advertisement and may comprise one or more lines of text, one or more images, and all combinations thereof. The publication may comprise a single advertisement or may contain more than one advertisement. Regardless of the number of advertisements and/or the number of products per advertisement, each unique product corresponds to a unique ID code of the disclosure. A reader having access to the print media may enter an ID code of interest into a code input device of the disclosure in communication with a computer to which the user has access. The code information is communicated to software of the disclosure which may result in the corresponding information file being downloaded and executed on the user's computer from the information warehouse on a second computer. In another embodiment, the file is executed from the second computer and displayed on a display device associated with said first computer. The user is thus able to view the information of the information file and may make selections pertaining thereto from the selection menu. Media, software and systems of the disclosure are described in further detail elsewhere in the present disclosure.

According to another non-limiting embodiment, the ID code is present on one or more type of hard copy print media and is associated with an information file that corresponds to an individual or group. As stated previously, hard copy print media includes but is not limited to magazines, newspapers, advertising flyers, directories, brochures, pamphlets, posters, tickets, collectible and playing cards, all types of cards, business cards, paper, and books. The information file may comprise one or more lines of text, one or more images, one or more pages, and all combinations thereof. The hard copy media may comprise a single ID code of the disclosure or may comprise more than one ID code wherein each code is unique to an information record. In one preferred embodiment, the ID code is present on a type of card or any type of paper and the corresponding information file comprises at least a portion of an individual's medical record, or an individual's education record, or an individual's employment record, or any combinations thereof.

According to even another non-limiting embodiment, the ID code is present on one or more type of label, tag, jewelry, ornamental-type item, and combinations thereof, and/or the ID coded may be tattooed on a person or animal. The label, tag, jewelry, ornamental-type item may be attached to or worn by a person, animal, product, object and/or article. The corresponding information file may comprise contact information for the parent, guardian and/or owner of the person, animal, product, object and/or article, contact information for the person/animal's doctor/veterinarian and/or hospital, any relevant health information pertaining to the person/animal for example any medications the person/animal might be taking (e.g., insulin, anti-seizure medication, etc), and/or any medical conditions the person/animal might have (e.g., diabetes, epilepsy, a neurological disorder, Alzheimer's, etc.), and all combinations thereof.

According to still another non-limiting embodiment, information relating to a person, animal, product, object, article and/or event is displayed on a display screen for example but not limited to an advertisement or announcement displayed on a television. Each advertisement or announcement may comprise unique embedded, encrypted and/or encoded data which corresponds to a unique ID code of the disclosure. The display device may be controlled manually, by remote control, or both. The control panel of the display device, the remote control for the display device, or both, comprise a dedicated button or key configured to be in communication not only with the display device but also with the information warehouse (via the Internet), or software of the disclosure loaded/installed on a computer accessible by a viewer of the display device, or both. The display device may also be configured to be in communication with the Internet. A viewer viewing the display device may press the button or key during display of an advertisement or announcement of interest. When a viewer presses the dedicated button or key during an advertisement or announcement of interest, the encoded data within the advertisement or announcement may result in the corresponding ID code being sent to the viewer's computer, and/or the corresponding information file of the information warehouse of the disclosure being executed and displayed on, and/or downloaded to the viewer/user's computer. For example, upon pressing the button or key during an advertisement or announcement of interest, a user may receive on his computer a confirmation message such as but not limited to an email or text message, containing the ID code for the corresponding information file. The user may then, at his convenience, enter the ID code into a system of the disclosure in order to view the corresponding information file. As another example, upon pressing the button or key during an advertisement or announcement of interest, the corresponding information file may be automatically executed from the information warehouse and displayed on the user's computer, or may be automatically downloaded from the information warehouse to the user's computer.

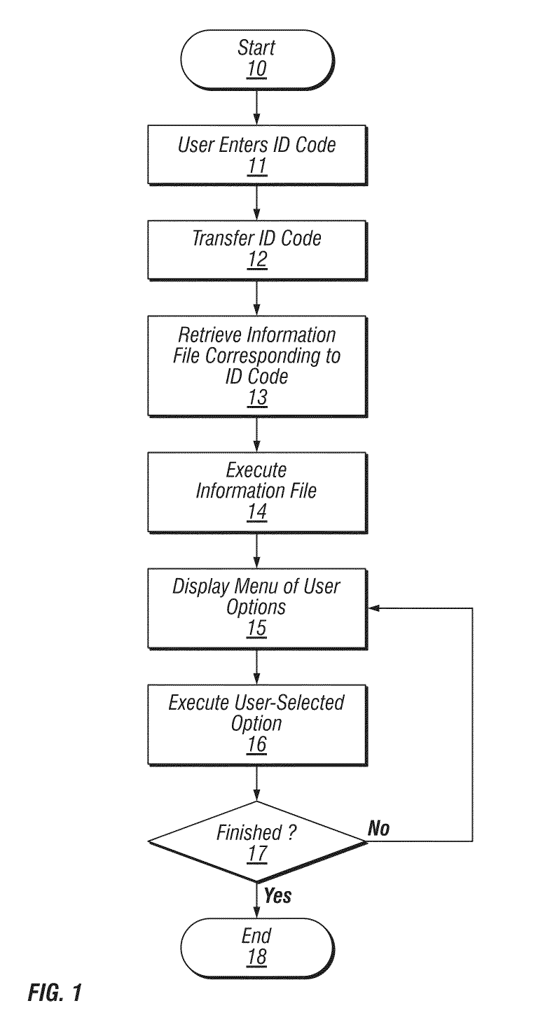

With the single step of entering an ID code of the disclosure into a system of the disclosure, a user is able to obtain on-demand information of interest via the Internet. Referring now to FIG. 1 there is provided a flow chart of a non-limiting method of the disclosure for providing on-demand information to a user. The method may begin in step 10. In step 11, an identification code (“ID” code) of interest may be entered by a user into a code input device of the disclosure. Code input devices include but are not limited to scanning devices, radio frequency detection devices, camera recognition devices, visual recognition devices, voice recognition devices, keyboards, keypads, touchscreens (including but not limited to surface computers and related technology), and any combinations thereof. The ID code may be entered manually for example but not limited to the user typing the ID code on a keyboard or keypad, for example but not limited to a computer keyboard, the keypad of handheld wireless device such as but not limited to a mobile phone, PDA, or similar device, or the ID code may be entered automatically by scanning the ID code for example but not limited to the user scanning the code with a scanning device, or placing the code in proximity to a touchscreen and/or surface computer having data entry capabilities, thereby enabling the screen/surface to receive the code data. In one non-limiting embodiment, the code comprises alphabetic, and/or numeric, and/or punctuation characters and is entered manually by being typed on a keyboard or keypad and does not require that the user have a scanner. In step 12, the code input device may communicate the ID code information/data to software of the disclosure loaded/installed on the user's computer. Generally, when an ID code of the disclosure is entered into a code input device of the disclosure, the ID code may be converted from optical information to digital information. This digital information is then further processed by software of the disclosure. Upon receiving the code information, the client-side software may validate the code information in order to determine if the information is recognized. If the code information is recognized, then the software may communicate the code information to the information warehouse of the disclosure on a second computer in order to retrieve the information file therein which corresponds to or is assigned to the ID code. If the code is not recognized, a message may be provided to the user for example but not limited to displaying a message on the user's display device in communication with his computer, or by playing a distinct and audible sound, or a combination thereof. As an alternative embodiment, or in addition, the code validation step may occur further downstream in processing and may be carried out by a server-side application installed on a second computer. In step 13, the client-side application may communicate the code information to a server-side application associated with the information warehouse of the disclosure installed on a second computer in order to retrieve the information file therein which corresponds to or is assigned to the ID code. As previously indicated, the information file may be any type of computer file known in the art for storing, processing, displaying and/or handling information including but not limited to a text file, an audio file, a graphic file, an animation file, video files, multimedia files, and all combinations thereof. In one non-limiting embodiment, the file comprises text and graphics. In another non-limiting embodiment, the file is a multimedia file. In step 14, the information file corresponding to the ID code of interest may be executed from the second computer and displayed on the user's display device in communication with the user's computer. The file may be automatically executed, or the file may be executed upon user-selection of a play option such as but not limited to “play”, “execute”, or “start”. In one preferred embodiment, the information file is automatically executed on the display device. In another embodiment, in step 14, the file corresponding to the ID code of interest may be downloaded from the second computer onto the user's computer and either automatically executed on the user's computer, or executed upon user-selection of a play option such as but not limited to “play”, “execute”, or “start”. In step 15, a function menu may be displayed on the display device. The function menu may be a file separate from the information file, or it may be incorporated within and thus a part of the information file. Generally, the function menu is a file separate from the information file. The function menu may include any one or more options known in the art such as but not limited to the following options: save file; add to wishlist; add to favorites; add to shopping cart; buy/purchase now; tell a friend; find a dealer; request additional information; contact source; go to a linked Website or Webpage (any one or more Websites and/or Webpages relevant to the information file of interest may each be configured to be a link/option within the menu including but not limited to the Website associated with the methods, media and systems of the present disclosure, and a Website associated with the content and/or topic of the information file); add user information to mailing list; fill out a survey, and leave a comment. The function menu and options may comprise any user interface technology known by one of skill in the art. Those skilled in the art will appreciate that user interface technologies and methodologies are well known, and thus are not repeated herein. In step 16, the user may select an option and the user-selected option may be carried out. With respect to the options of the function menu, each option may be configured to link to a relevant set of operational instructions for executing the selected option. As stated, the function menu and options therein may comprise any user interface technology known in the art. In step 17, it may be determined whether or not the user is finished selecting options. If no, the user is not finished, the method may return to step 16 for selection of one or more additional menu options. A user may return to the function menu any number of times to select any one or more additional options therefrom. If yes, the user is finished making selections, then the method may end in step 18. When the method ends, the option menu may be configured to close automatically, or to close upon user request, or a combination thereof. For example, the option menu may be configured to close after a designated period of time if the user does not close the menu. In one embodiment, the function menu file is executed from the second computer associated with the information warehouse via a web browser on the user's computer.

According to yet another non-limiting embodiment of the disclosure there is provided software enabling a user to obtain on-demand information. This software may also be referred to herein as “client-side software”. Generally the software comprises a set of instructions that when executed on a computer enable said computer to process ID code data/information of the disclosure. In a preferred embodiment, on a computer on which the software has been loaded/installed, the processing instructions are automatically executed when ID code data/information is entered in the software/application. Processing may comprise receiving ID code data/information from a ID code input device. Processing may comprise transferring the ID code information and any data relating thereto to an application installed on a second computer associated with the information warehouse of the disclosure. Transferring the code information from a first computer to a second computer may be in the form of a request by the first computer for the ID code and/or the information file corresponding to the ID code of interest. Transferring the code information to a second computer may comprise use of proxies, gateways, tunnels, and any other intermediary network protocol/component known in the art. The second computer may decode the ID code data/information in order to identify and retrieve the corresponding information file. Processing may comprise executing the corresponding information file from the information warehouse and displaying it on the user's computer. In another embodiment, processing may comprise first downloading the corresponding file onto the user's computer. In one non-limiting embodiment, upon receipt of ID code information, the software of the disclosure is configured to automatically execute the corresponding information file from the information warehouse and display it on the user's computer. In FIG. 1, step 11 (user enters an ID code) is the only step of the method that a user must perform in order to receive the information of interest.

The client-side software of the disclosure may comprise a set of instructions that when executed on a computer enable validation/authentication of an ID code received on said computer in order to determine whether the code is a valid code of the information warehouse although generally an ID code validation step is carried out by a server-side application. The instructions may comprise one or more communications protocols that when executed on a computer enable the computer to communicate with code input devices of the disclosure, the server-side application associated with the information warehouse of the disclosure, the Internet, or a second computer on which the server-side application is installed and/or the information warehouse is maintained, or any combinations thereof. As an alternative or in addition, the ID code authentication step may occur further downstream in processing and may be carried out by server-side software of the disclosure and/or by any intermediary network protocol and/or component.

With respect to both client-side and server-side software of the present disclosure, the software may be written in any one or more suitable programming languages known in the art. The software of the present disclosure and also the information warehouse of the present disclosure are compatible for use with any software platform and/or operating system. The client-side software of the disclosure may be downloaded from a Webpage associated with the present disclosure and may be obtained by any individual having access thereto. Generally, obtaining the client-side software of the disclosure does not require special authorization. The client-side and/or server-side software of the disclosure may be encoded on any of a variety of media including, but not limited to, computer-readable media, machine-readable media, program storage media or computer program product. Such media may be handled, read, sensed and/or interpreted by any information handling system (IHS).

For ease of operation, the client-side and/or server-side software of the disclosure may undergo initialization upon start/boot up of a computer on which the software has been installed. Once initialized, the client-side software may be configured to display an ID code input window or box on the computer's display device for receiving ID codes and into which a user may enter/type ID codes of the disclosure. The ID code input window or box may be automatically displayed upon initialization of the software. Generally the ID code input window or box is visible and convenient to a user of the computer, but is not obtrusive to the user and operation of the computer. For example the ID code input window or box may be located on a taskbar or on the desktop.

According to even still other embodiments of the present disclosure there are provided methods, media and systems allowing one or more authorized individuals/parties to receive and/or access information relating to any one or more information file in the information warehouse. For monitoring and/or tracking purposes, any one or more event relating to the information files of the disclosure may be added to one or more designated databases. Thus, events occurring with respect to each information file of the disclosure may be monitored and the data maintained in one or more designated databases. As defined herein “events” include but are not limited to ID code entering/scanning events and related data, file download events and related data, file execution events and related data, any one or more option selection events (i.e., user selections from a function menu) and related data, any information regarding entry and/or removal of an information file into or out of the file system such as dates and/or times thereof, information regarding access to the information file in the file system and data relating thereto such as the party accessing the file, dates and/or times thereof, any type of bookkeeping information, and all combinations thereof. For example, each time an information file is downloaded onto a computer, the occurrence of the download event and any related information such as date and/or time of the event may be added to one or more designated databases. Each time an ID code is entered and/or scanned, the event and any related information such as date and/or time of the event, and/or source of the ID code may be monitored and the data added to one or more databases. Each time an information file is executed and/or displayed on a display device, the event and any related information such as date and/or time of the event may be monitored and the data added to one or more databases. Each time a user selects an option from a function menu, the selection event and any related information such as date and/or time of the event may be added to one or more designated databases. The event information may be maintained in one or more designated databases. The one or more databases may be specific to a single type of event and comprise information regarding a single information file or more than one information file, or they may comprise data regarding more than one type of event and may be directed to a single or more than one information file, or any combinations thereof. Methods for managing data, compiling and maintaining lists, and compiling and maintaining databases are known by one of skill in the art, and any such methods are suitable for use herein. Generally the one or more databases are maintained on the same computer on which the information warehouse of the disclosure is maintained.

All or part of the data in the one or more databases may be obtained by an authorized party either by direct access to the data, by indirect access to the data via submitting a request/query, or any combinations thereof. Alternatively, or in addition, all or part of the data in the one or more databases may be configured to be automatically sent to an authorized recipient/party according to a schedule, for example but not limited to each time the database is updated, or after a certain time interval has lapsed, or after a database is updated a certain number of times, or all combinations thereof.

As defined herein, an authorized party may be any one or more individuals granted either direct or indirect access to information in one or more of the databases and is generally an individual or party associated with the subject of an information file of the disclosure such as but not limited to the owner of the information warehouse, a party designated by the owner of the information warehouse, an advertiser and/or producer and/or a marketer of a product of an information file of interest, and/or a party designated thereby, an individual or group referenced in the information file or a party designated thereby, and all combinations thereof. Generally the owner and/or administrator of the information warehouse, or a party designated thereby, is responsible for granting, suspending, terminating, denying, and all combinations thereof, authorization to access file information. By accessing and/or receiving event information of the database(s), an authorized party may track events such as but not limited to how many times an ID code has been scanned and/or entered, or how many times an information file relating to a product he supplies has been executed and/or downloaded, or purchasing information on one or more products he supplies and/or sells, or obtain user feedback information, or any combinations thereof. An authorized party is also able to track event activity with respect to periods of time, one or more or a range of dates, and combinations thereof. The tracking/event data may comprise the specific site/source of the information file of interest. For example, for an ID code printed in a publication, part of the code may comprise unique source data corresponding to the publication and unique publication information such as but not limited to the publication's title, publication issue and/or date, page on which the ID code appears, and all combinations thereof. Thus, an authorized party may track event activity with respect to any one or more sources of interest comprising any one or more ID codes of the disclosure. For example, an authorized party may query for event activity relating to any one or more specific media source such as but not limited to a particular magazine or a particular newspaper. This capability allows an advertiser/marketer to determine the effectiveness of a particular ad and/or particular publication. Generally the ID codes of the disclosure are configured to comprise all the relevant source tracking data pertaining thereto, such that scanning/entering an ID code of interest into a system of the disclosure results in all corresponding source data automatically being saved in one or more designated databases. With the ability to track event activity relating to any one or more information file of interest and/or any one or more media source of interest, an authorized party such as but not limited to an advertiser/marketer is able to analyze and/or modify and fine-tune his advertising/marketing strategies.

The tracking software of the disclosure comprises a set of instructions that when executed on a computer enable the computer to track any type of activity and bookkeeping data relating to the ID codes, information files, the information warehouse, and databases of the disclosure. Generally, the tracking software comprises server-side applications and is thus also referred to herein as “server-side software”. The tracking software of the disclosure is generally loaded/installed on the computer on which the information warehouse is maintained. The tracking software is generally for use only by authorized parties such as the creator/author and/or administrator of the information warehouse. In one embodiment, all activity relating to the ID codes and the information files is monitored and the data added to the databases of the disclosure. The tracking software may comprise a set of instructions that link an option menu file to each information file when the information file is executed and displayed a user's computer. Generally an option menu is displayed to a user following execution of each information file.

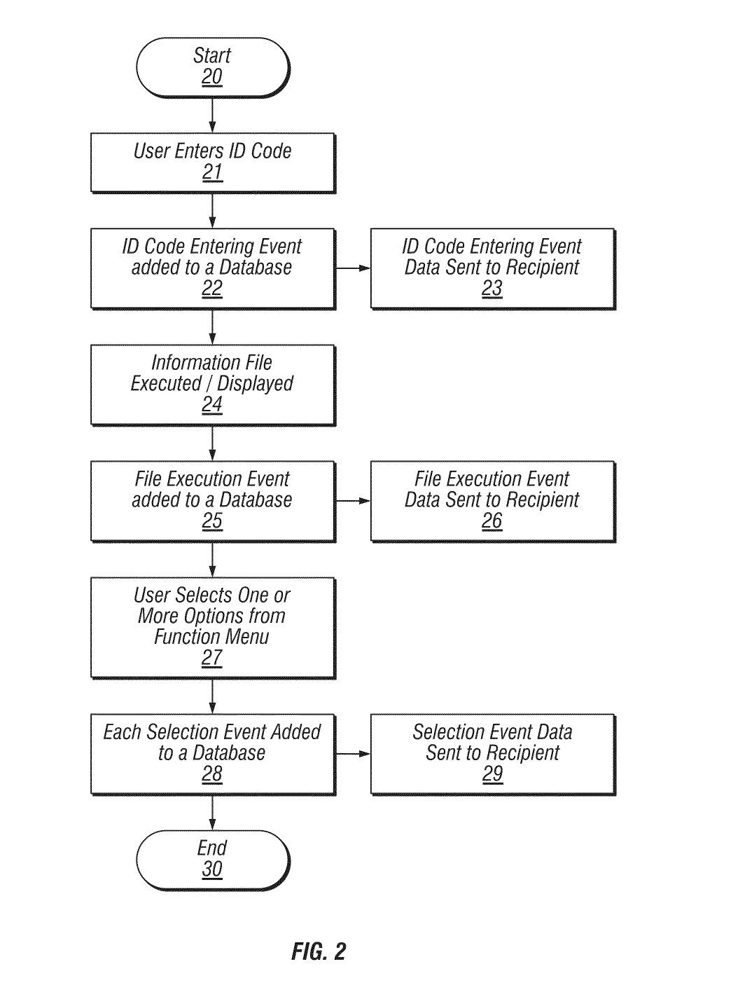

Referring now to FIG. 2 there is provided a flow chart of a non-limiting method of the disclosure for monitoring event data relating to information files in an information warehouse. The method may start in step 20. In step 21, an ID code may be scanned or entered by a user as described previously. In step 22, the event and related information such as date and/or time of the event may be added to a designated database. Related information may comprise the source/reference data for the ID code being scanned/entered such as a publication reference, a television or radio commercial reference. For example if the ID code of interest is entered from a printed publication, related information may comprise data such as the title, issue, and/or page number of the publication. For those ID codes in publications and/or on commercials, the ID codes are created so they comprise source data unique to the publication or commercial thereby enabling tracking of these sources. In step 23, the event and related information such as date and/or time of the event may be automatically delivered to a recipient. In step 24, the information file corresponding to the scanned/entered ID code is executed and displayed onto a computer. In step 25 the file execution event and related information such as date and/or time of the event may be added to a database and in step 26 the file execution event may be delivered to an authorized recipient. In step 27, a user may select an option on the function menu. In step 28 the selection event and related information such as date and/or time of the event may be added to a database and in step 29 the selection event data may be delivered to an authorized recipient. Steps 23, 26 and 29 may be configured using any of a number of parameters for example, the data contained therein may be sent to a recipient as a batch of data instead of individual data. The data may be sent to a recipient only after a designated time period has lapsed. Configuring parameters for data transfer are known to those of skill in the art and all are suitable for use herein. Generally the one or more databases are maintained on the same computer on which the information warehouse of the disclosure is maintained. In one non-limiting embodiment, the recipient is an advertiser and/or marketer and the event information relates to how many times an ID code and/or information file corresponding to a product he supplies and/or produces has been entered, scanned, downloaded, or executed, or any combinations thereof. In another non-limiting embodiment, the recipient is an advertiser and/or marketer and the data comprises selection events such as but not limited to purchasing information relating to a product he supplies and/or produces, and/or customer feedback relating thereto. As an alternative or in addition, all or part of the information in the database(s) may be obtained upon request by an authorized party. For example, as an alternative or in addition to automatically receiving event information relating to information files of interest, an authorized party may request event information of interest relating to information files of interest by submitting a request for event activity using parameters such as but not limited a period of time, one or more than one or a range of dates, specific ID codes, etc. Or a query may be made to determine how many times any one or more codes in any one or more media source have been entered and their corresponding files executed and/or downloaded. A query made be made to determine which inquiries and/or choices any one or more user makes/selects from the option menu. The method may end in step 30.

As stated previously, as used herein an “authorized party” may be any one or more individual granted direct and/or indirect access to file information data and is generally an individual or party associated with the subject of an information file of the disclosure such as but not limited to the owner of the information warehouse, a party designated by the owner of the information warehouse, an advertiser and/or a marketer of a product of an information file of interest, and/or a party designated thereby, and all combinations thereof. Generally the owner of the information warehouse, or a party designated thereby, is the party who grants, denies, suspends and/or terminates authorization to access file information.

According to yet even other non-limiting embodiments of the present disclosure there are provided systems for providing on-demand information to a user. With respect to the systems of the disclosure, generally the systems comprise a code input device in communication with a first computer having installed thereon software of the present disclosure, a display device in communication with said first computer, and a second computer wherein the first and second computers are able to communicate with one another. In one non-limiting embodiment the first and second computers communicate with one another via the Internet. The code input device may allow for automatic input of an ID code of the disclosure, manual input of an ID code of the invention, or both. Code input devices include but are not limited to scanning devices, keyboards and keypads such as but not limited to a computer keyboard, keypad of a mobile phone, keypad of a handheld computer, keypad and any wireless handheld device. The first computer may be a desktop, laptop, handheld computer, or any computer known in the art. The display device may be a component separate from the computer such as but not limited to a computer screen/monitor or a television screen. The display device may be a part of the computer body such as but not limited to a laptop screen, or a display screen of a handheld computer. Display devices for computers and computer-based technology are known, and any are suitable for use herein. The information warehouse is present on the second computer. The second computer may also comprise the one or more databases (also referred to herein as “tracking” databases) comprising event information (also referred to herein as “tracking” information) described in detail elsewhere in the present disclosure.

As known by one of skill in the art, the first computer may be considered a client when requesting an information file from the information warehouse, and the second computer may be considered a server when communicating with said first computer and/or providing an information file thereto. Any client-server request/response protocols known in the art may be utilized herein for communications between the first and second computers. Communications between the first and second computers may comprise any one or more intermediary network protocols and/or components such as but not limited to proxies, gateways, tunnels, and combinations thereof. Such intermediary protocols and/or components are known by those of skill in the art and are thus not described in additional detail herein.

With respect to scanning devices suitable for use as code input devices in the methods and systems of the present disclosure, any such devices known in the art are suitable for use herein. The scanning devices may be conventional scanning devices or they may be scanning devices designed especially for the methods and systems of the present disclosure. The scanning devices of the disclosure generally comprise an optical input section, a digital processing section and an output section. The scanning device may be a separate component in communication with a computer, or may be a physical part of a computer. The scanning device may be designed in the form of for example but not limited to a wand, a pen, a mouse for a computer, a mobile phone, a camera, a handheld computer, a handheld scanner, a flatbed type scanner, and all combinations thereof. For convenience, the scanning device may be a wearable device and/or the scanning device may comprise a clip or other attachment means allowing a user to attach or affix the device to items such as but not limited to clothing, backpacks, purses, briefcases, totes and all combinations thereof. The scanning device may be a wireless device, a wired device, or capable of functioning as either type of device.

Another of the many advantageous features of the present disclosure is the flexibility provided to a user. In one embodiment, the ID codes comprise alphabetic, and/or numeric and/or punctuation characters, and the code input device is a keyboard or keypad, and the system does not require a scanning device. For those users who do not own, or do not wish to own, or are unable to obtain a scanning device, use of a computer keyboard or keypad for the code input device is completely sufficient. Thus, anyone with access to a computer is able to use the methods of the disclosure upon installation of the software of the disclosure onto said computer. Any user may choose to utilize a scanning device as the code input device however the use of a scanning device for entering the ID codes of the disclosure is not a requirement for the present disclosure.

In those embodiments wherein an ID code is entered by scanning with a scanning device, generally the code input device is a portable, wireless scanning device. For ease of use and mobility, generally the scanning device is in the form of a pen, a wand-like object, built into a mobile cell phone, built into a handheld computer, or any combinations thereof.

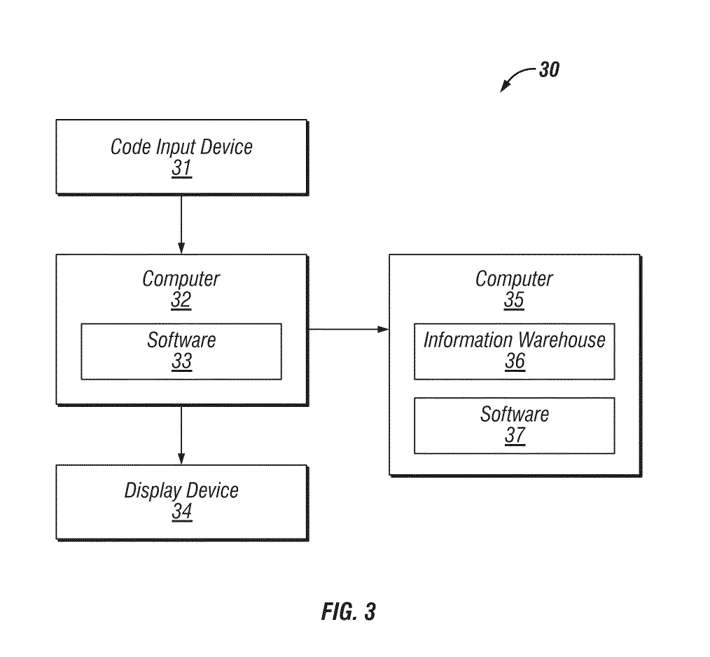

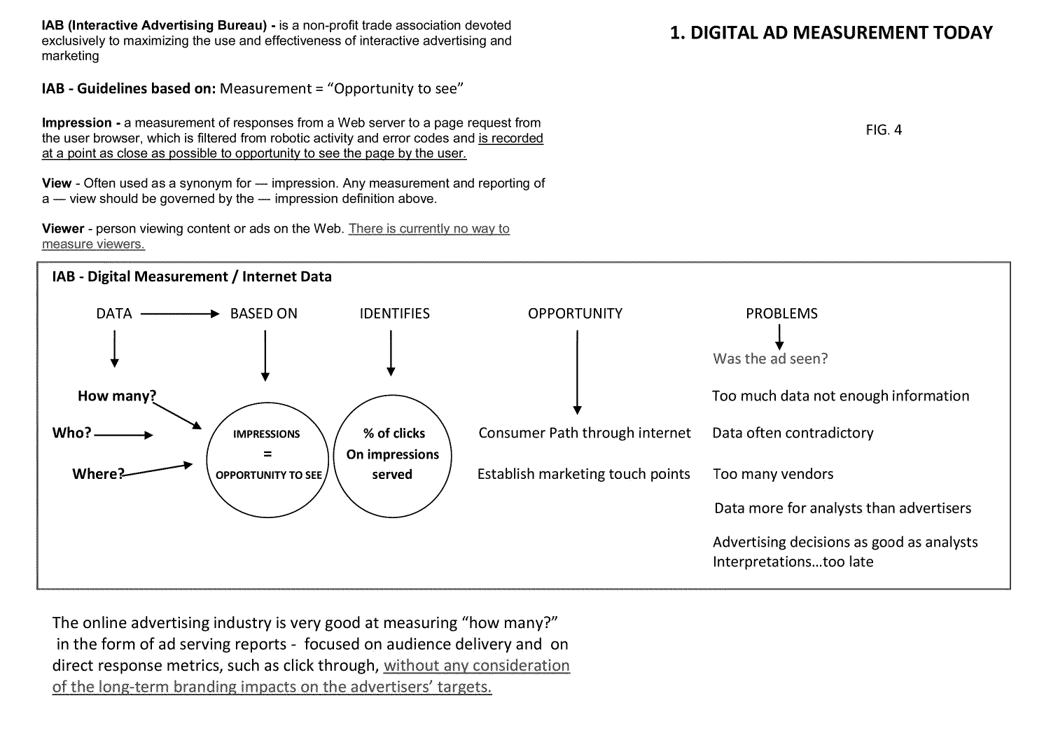

Referring now to FIG. 3 there is provided an illustration of non-limiting system 30 of the disclosure. System 30 comprises code input device 31 which is able to communicate with computer 32 having software 33 installed thereon. Software 33 is client-side software and enables computer 32 to communicate with computer 35 containing information warehouse 36. Software 33 also enables computer 32 to communicate with code input device 31. Software 33 may also enable computer 32 to communicate with the Internet. In one preferred embodiment, computer 32 and computer 35 communicate via the Internet. Computer 35 has software 37 installed thereon which enables computer 35 to communicate with information warehouse 36. Software 37 is server-side software. A user may enter an ID code in system 30 using code input device 31. Code input device 31 relays the ID code input data to computer 32. The event of receiving the ID code data/information by computer 32, automatically executes a set of instructions of software 33 which in turn communicates the ID code input data on computer 35. This communication may be in the form of a request for the corresponding information file from information warehouse 36. The corresponding information file is executed from information warehouse 36 to computer 32. The file is displayed on display device 34 which is in communication with computer 32. The function menu for the executed file is then displayed on display device 34 from which the user may make one or more selections. As known by one of skill in the art, communication between components of a system may be through wired communication links and/or by wireless communication links. Any such communication means known in the art may be used in the present systems. Communication may also involve any one or more intermediary protocol and/or component and all such intermediaries known in the art are suitable for use in the present systems.

Generally the files of the information warehouse of the disclosure are executed and/or downloaded onto a user's computer via the Internet. Although a Website may be associated with the methods, media and systems of the present disclosure, neither the information files nor the information warehouse are accessible to and/or viewable by the public via the Website. In addition, a user is not required to view the Website or any other Website and/or Webpage in order to executed and/or download information files of the disclosure. One of the many advantageous features of the present disclosure is the ease with which a user may obtain on-demand information from the Internet without having to navigate, search, browse and/or view a Website or Webpage. The Website associated with the present disclosure generally comprises at least one Webpage accessible to any individual surfing/browsing the Web upon said individual entering the Web address for the Webpage, or being directed or otherwise linked to the Website. The at least one Webpage may comprise any information relating to the methods, media and systems of the present disclosure including but not limited to: information directed to client-side software of the disclosure for example how to download said software, client-side software specifications, and/or a link thereto; information describing the history/background and/or features of the methods, media and/or systems of the disclosure and/or a link thereto; information describing who to contact and/or steps to take in order to become an authorized user and/or how to establish a user account and/or a link thereto; information enabling authorized users to access their respective user account(s) and/or a link thereto; information regarding how to submit an information file(s) for storage thereof in the information warehouse and/or a link thereto; and all combinations thereof. The Website may also comprise contact information for individuals/groups/businesses (i.e., authorized users) who have information files in the information warehouse of the disclosure, and/or links to Websites of such individuals/groups/businesses.

For those users who do not wish or are unable to download the client-side software onto the computer from which they have accessed the Website, and/or for users who have yet to download the client-side software onto their computer, the Website may comprise a Webpage having an ID code input box into which an ID code of the disclosure may be entered. This enables the user to obtain the information file corresponding to an ID code of interest without necessarily having to download the client-side software onto the computer he is using. The user may be presented with the option to download the client-side software thereby saving him the future task of manually returning to the Webpage.

As discussed previously, if a user chooses to download the client-side application onto his computer, the application will be installed on his computer and generally will boot up automatically everytime the user's computer is booted. In addition, the application will install an input box on the task bar/deskbar of the user's computer's display device. Thus, anytime the user wishes to retrieve an information file from the information warehouse, he does not have to first open any applications but rather will only have to enter in the ID code of interest into the input box. The client-side application installed on his computer may then: 1) open the users' browser; 2) open the automated version of the information warehouse's Web page; and 3) transmit the keyword to the Web server which will then retrieve the corresponding information file of interest from the warehouse and display it on the user's computer's display device. Generally, the server will be able to detect if a visitor to the Website has the client-side application installed on his computer and will not bother him with the download software request. As known in the art, the download method will comply with all legal issues of downloading applications to a user computer

Information on the Website directed to authorized users may be maintained on one or more Webpages of restricted access wherein the pages are viewable only after an authorized user signs in or logs in. For example, information on how to request and/or obtain tracking information from any one or more of the databases comprising tracking information, information on how to modify a user account and/or it's settings, and information on how to request modifications to information files, may be visible only after an authorized user has logged into his user account or entered a pre-approved password required to access restricted-use Webpages of the Website.

The Web address and/or domain name of the Web site may be displayed anywhere an ID code of the disclosure is present. The Web address and/or domain name may accompany any ID code of the disclosure on any media having an ID code thereon. For example, an advertisement in a magazine may comprise an ID code of the disclosure for a product advertised therein, and the Web address and/or domain name may also be present for a user's reference. Generally for ease of reference, the Web address and/or domain name is positioned in proximity to the code but will not interfere with a scanning device scanning the code.

As previously stated, neither the information warehouse nor the information files themselves are accessible to and/or viewable by the public via the Webpage(s) of the Website. That is, the information files and the information warehouse are invisible/transparent to the public and may also be invisible/transparent to authorized users. In addition, when a user enters an ID code into a system of the disclosure, the user is not directed to, nor does the user see the Website associated with the disclosure but rather the user sees only the execution of the information file corresponding to the ID code of interest to him. Thus the methods, media and systems of the present disclosure allow a user to obtain on-demand information from the Internet while bypassing the need for the user to view and/or browse the Web in order to do so.

Generally only a designated party responsible for maintaining the content of the information warehouse, the tracking databases, and/or the Website, or a party designated thereby, is able to view and access the information files, the tracking databases, and information warehouse. The designated party may be, for example, the creator and/or owner and/or administrator of the information warehouse or party designated thereby, the owner of the Website or party designated thereby, the author of the Website or party designated thereby, the system administrator for the Website or party designated thereby, the Webmaster for the Website or party designated thereby, and any combinations thereof. The designated party is generally responsible for modifying the content of the information warehouse (e.g., adding information files, removing information files, assigning ID codes to information files, modifying information files, and combinations thereof) and for maintaining the tracking databases of the disclosure.

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by an information handling system (IHS). Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). Such media and methods for creating same are known by one of skill in the art and any are suitable for use herein. The methods, media and systems of the disclosure comprise use of computers, the Internet and Web. All technology known by one of skill in the art for utilizing computers, the Internet and the Web including but by no means limited to programming, database operations, data transfer, communication protocols, network protocols and components, client-server protocols, and Website engineering are suitable for use here. It should be understood that the given implementations are illustrative only and shall not limit the present disclosure.

According to yet still another embodiment of the disclosure there are provided products, each comprising at least one unique identification code of the disclosure. Products of the disclosure include any product having an ID code of the disclosure thereon as described previously. Products include but are not limited to any one or more type of hard copy media and/or printed media as described elsewhere in the disclosure, any one or more types of label, tag, jewelry, ornamental item or similar item as described elsewhere in the disclosure that may be affixed or worn or attached to a product, object, article, person, and/or animal. In one non-limiting embodiment, the product is a print media product comprising one or more printed portions wherein each portion comprises an ID code of the disclosure. In one preferred embodiment the print media product is a magazine.

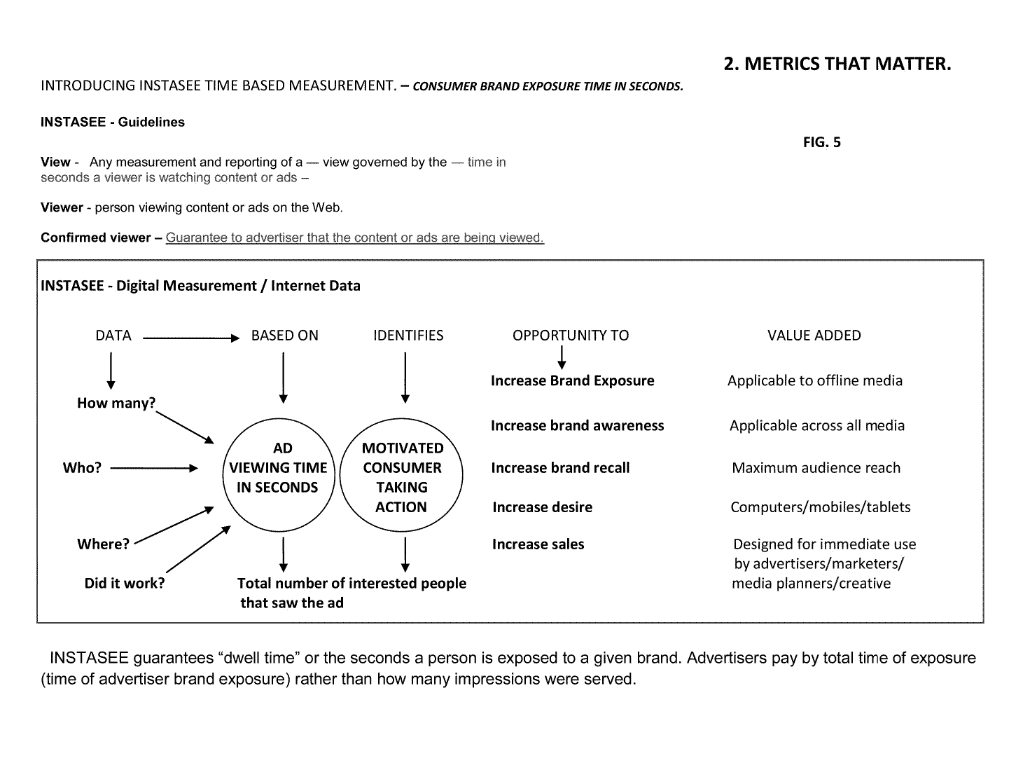

Referring now to FIG. 5, there is a schematic representation showing a non-limiting embodiment of the digital advertising method, apparatus and product of the present invention.

TABLE
Industry Needs

| | One or more of the non-limiting |
|---|---|
| INDUSTRY NEEDS | embodiments of the present invention. |
| deliver Anytime Anywhere | all consumer cross-media access |
| Media Measurement (A2/M2) | exactly measurable |
| compare the Internet to | lcan present brands uncluttered, on a |
| television in a way | full screen, brand exposure time is |
| acceptable to TV ad buyers | measured in seconds, just like TV |
| measure ad effectiveness | the on-demand nature of various |
| rather than just ad | embodiments deliver a motivated |
| delivery time | potential customer (rifle shot not |
| | shotgun) to an interactive multimedia |
| | platform with soft-keys for further |
| | viscosity |
| track the percentage of | monitors the primary action taken (a |
| total impressions that | click) per ad, dwell time in seconds in |
| result in an action taken | front of the brand, and secondary |
| | action through soft-keys: it also |
| | identifies the source |
| shift advertiser attention | measures campaign effectiveness |
| from the delivery of the | through tracking primary and |
| specific unit to the | secondary action taken, by target |
| quality of the overall | audience, by ad, by medium, by |
| campaign delivery | insertion, etc. It can measure, for |
| | example, share shift, all media GRP, |
| | cross-platform engagement, etc |
| measure the overall time a | the overall time a consumer is |
| consumer is exposed to a | exposed to the brand is increased: the |
| given brand's ads | dwell time on the advertiser's |
| | enabled page is measured, as is the |
| | secondary dwell time of the |
| | consumer's journey through soft-keys |

The present invention overcomes a lot of the deficiencies of prior art systems, and addresses many needs of the industry as shown in the following Table.

Non-limiting embodiments of the present invention, allow inquiry into the core principles of successful advertising, that is, the three basic questions: of (1) How many?; (2) Who?; and (3) Did it work?

In the practice of the present invention, the “How many?” may be a function of the volume of ads, using measures like impressions, gross rating points (GRP) and the like. In one non-limiting embodiment of the present invention, the “How many?” is the total of actual visits/viewings and GRP is total viewings divided by total population.

In the practice of the present invention, the “Who?” may be the targeted audience, and may include whatever parameters are selected to define the desired population, non-limiting examples of which include age, income, education and household size. In one non-limiting example of the present invention, the “Who?” may be obtained by identifying the source media from which the product inquiry was made.

In the practice of the present invention, the “Did it work?” is the effectiveness of the campaign. In one non-limiting embodiment of the present invention, the “Did it work?” may be based on actual consumer responses with exact time spent in seconds by a person in front of the brand.

Certain non-limiting embodiments of the present invention may comprise a Multimedia Distribution Network designed for maximum audience reach with the ability to communicate messages one-on-one to the general public and the mass media.

Various non-limiting embodiments of the present invention may provide a unique tracking and time based measurement metric system that may focus on consumer brand exposure.

One non-limiting embodiment of methods, apparatus and products of the present invention may be explained as follows.

(1) Include a simple keyword or name ID to be used with printed material, or any media, e.g., “012 jobs”, “015 energy”, “2012 I'm in”.

2) The user enters the chosen keyword or name ID on the user's computer or mobile to receive full and persuasive video information, instantly. There are no intermediate steps to discourage or delay the user. QR Codes may be used as an alternative if preferred. On the internet access to video is simply by clicking on a link or an ad.

3) Tag everything that carries the message, Print, Internet, Billboards, TV, Radio or any campaign materials such as coffee mugs, t-shirts, or flyers, as non-limiting examples. These name ID tags may be digitally communicated quickly (as non-limiting examples, e-mailed, texted, exchanged between devices, etc.) for immediate action or sent to newspapers and magazines to quickly be printed and inserted in advertisements, articles, and editorials, or be used by a talk show host or a news network. These tags can be shared online through social networks such as Facebook and Twitter where they acquire a life of their own. The more the tags move, the more the “message grows and penetrates” the population.

Various embodiments of the present invention allow for a single voice campaign, no distortion, and total control of information, and may allow for an extremely fast response.

According to one non-limiting embodiment of the present invention, advertising effectiveness may be measured as follows:

1) A non-limiting embodiment of the present invention may track each ad video byte or “still” viewed by the public across all media advertisements. According to the present invention, key elements may be measured that may answer questions such as, How many? Who? Where? How much dwell time? In the practice of the present invention, these measurements are based on “actual” responses not after the fact “surveys” to provide advertisers with the information needed to respond faster in the Media.

2) In one embodiment of the present invention, a marketing “war room” may be provided wherein the data are projected on computer screens, in real time, on a selected time basis (i.e., could be daily, weekly, weekend, hour, any desired window or time period), in an easy to use “dashboard format”. One or more embodiments of the present invention may track performance, measure progress, and provide immediate viewer response to an advertising message. Various embodiments of the present invention may show one or more of how many videos have been viewed, who viewed them, from where, how much time they spent viewing each video, whether readers were engaged with the message, which issues or brands are doing better and where, and which issues or brands are doing worse . . . and more. It is anticipated that security clearances may provide various personnel with access to none, part or all of the access depending upon the level of clearance. According to the present invention, data may be provided for by political boundaries, such as Country, State, County, City, district, and/or precinct. Any other suitable geographic divisions may be utilized as desired.

As a non-limiting illustration, the results are shown by:

Total of all linked media purchased.

Media category (print, internet, outdoor, TV, radio, outdoor, in-store)

Media type (magazines, newspapers, cable TV, brochures, direct mail, etc.)

Individual media: (which magazine, newspaper, newspaper App, website, TV, etc.)

According to various non-limiting embodiments of the present invention, targeted audiences may be observed reacting to an ad: provided may be instant “mass media audience feedback”, arguably the “golden chalice” of a campaign. The total time viewers spend in front of the message may be given in “Consumer seconds” and may act as a meter with the needle showing if the advertising is working and the message is getting through. Adjustments/reactions may be made in real time by bringing adjustments and refinements to the message, shift the time slot, shift the geographic selection, pull it or replace it instantly, without the need to change a Print ad's copy or the name ID tag that is on the ad. Non-limiting embodiments of the present invention allow for change of the accompanying video or addition/substitution of new ones. The number of videos that may be stored is only limited by storage capacity.

4) in the practice of the present invention, it is anticipated that optional “soft keys” may be available for the user to click on to show additional videos or to respond to a “call to action” that may takes the viewer to some next step as provided: non-limiting examples of which include—register, become a member, donate, vote, print out information, or link to other information such as “Where to Buy” or “A Store Near You”, Purchase Online. This is a strategic interactive function to build engagement and increase time spent in front of a message—a principal objective and an effective strategy in the advertising industry.

The present invention provides various non-limiting embodiments for determining video viewing time, which can be measured in any desired time unit, including seconds, minutes, fractions of a hour, tenths of an hour, hour, days, weeks, months, etc.

According to a non-limiting embodiment of the present invention, video viewing time can be obtained utilizing a unified web-based real-time video measurement system that uses an application server, configured for executing a video application defined by combination of web technologies (non-limiting examples including HTML, CSS, PHP, JavaScript, Ajax, and certainly any others that are suitable and/or that might be developed in the future), and accesses user and video attributes from a standardized information database server (a non-limiting example of which includes MySQL, and certainly any others that are suitable and/or that might be developed in the future). As a non-limiting example, the application server, upon receiving a video viewing request from a browser serving a user, accesses the users' browser and video hosted on the standardized database server to obtain detailed data information for a video viewing request. As a further non-limiting example, the application server generates an HTML document containing statistical content about the frequency, length and geography of each video viewed which is utilized to simplify the planning of online video campaigns and provides insight into consumers' digital video viewing behaviors.

According other non-limiting embodiments of the present invention, the present invention provides various non-limiting embodiments for determining “still” viewing time, which can be measured in any desired time unit, including seconds, minutes, fractions of a hour, tenths of an hour, hour, days, weeks, months, etc.

A non-limiting a non-limiting embodiment of the present invention, a “dedicated product landing page” is utilized to measure “still” viewing time. As a non-limiting example, when using stills, the duration between time the page was accessed up to the time when the user clicked on the first soft key is calculated. The time between subsequent other Soft Key clicks” is calculated to determine the viewing time of each still image or information accessed through each Soft Key. How much time a viewer is looking at a each specific image or document and how much time a viewer is looking at the information in total may be provided through any suitable reporting mechanism (web-based, emails, texting, faxing, mailed, etc.) in any suitable report format.

The present invention will allow analysis of an online advertising campaign as follows. The number of viewers for a minimum amount of time, for example, 12 million people in front of the message for 90 seconds. The biggest/least impact in which geographic regions (i.e., country, region, state, country/province, metro area, city, district/precinct, etc)., for example, the biggest impact was in the following states . . . the least was in . . . . The best performing media outlets with relevant demographics. Details regarding the various media, for example, of the 5 videos sent out, these 3 did remarkably well, with number of viewings, and interaction with the videos was high. Video lengths were 15 seconds. and 20 seconds, and consumers viewed 96% of the total video content delivered. The other 2 videos have to be changed. Viewing time lasted only 22% of content. The interest was there because the number of visits was high, but interested consumers just did not react to the content or did not find the videos compelling. X % of the response came from mobiles. This data may suggest that for the next launch, pull out of the non performing mediums and allocate those dollars to those that have been more effective”.

Clearly, the level of information derived from the present invention is unprecedented and the fact that with some non-limiting embodiments these results can be generated in real time instantly for immediate use offers an advantage only dreamed of in previous campaigns. The present invention may provide benefits for advertisers and media buyers involving huge amounts of money in one of the largest categories of indirect spend of any company, CMO's want proof that their advertising is working and what specific results can be attributed to it. Various non-limiting embodiments of the present invention provide solid data and measurement to support judicious media decisions. The present invention provides a better way to measure the consumer impact of advertising dollars spent across different media, and enables the first true evaluation of cross-media advertising spends.

The present invention may provide benefits for creative insight into how users engage and respond to particular ads. Precise measurements in <<consumer-seconds>> and total time spent in front of the brand provide a better evaluation of the effectiveness of your creative.

The present invention may provide benefits for consumers being <<found>> is one of the most important and cost effective ways to attract customers on the internet. The present invention insures that those consumers wanting more information can easily find it, resulting in a targeted lead for the advertiser and an easier, one click, process for the consumer. <<What you want to know and only what you want to know>> in one simple computer/mobile transaction without searching or browsing. Research shows that consumers who interact with ads tend to be more valuable to the advertiser.

The present invention may provide benefits for brands. Sites create cluttered environments where a consumer is moved quickly from one ad unit to another so that the consumer can be exposed to as many ads as possible. With so many ads delivered in short periods of time it is very difficult for any given ad to produce a brand narrative that connects with a target consumer. The present invention presents brands uncluttered, on a full screen, and increases the overall time the consumer is exposed to the brand through interactive soft keys. It stands to reason that the longer a person is exposed to a good creative unit the more effective the unit itself will be.

The present invention may provide benefits for publishers. INSTASEE is the ideal method for any publisher to prove to their advertisers that their ads work. The present invention metrics show the number of actual consumer responses to each specific ad, what action was taken, for how long, in real time.

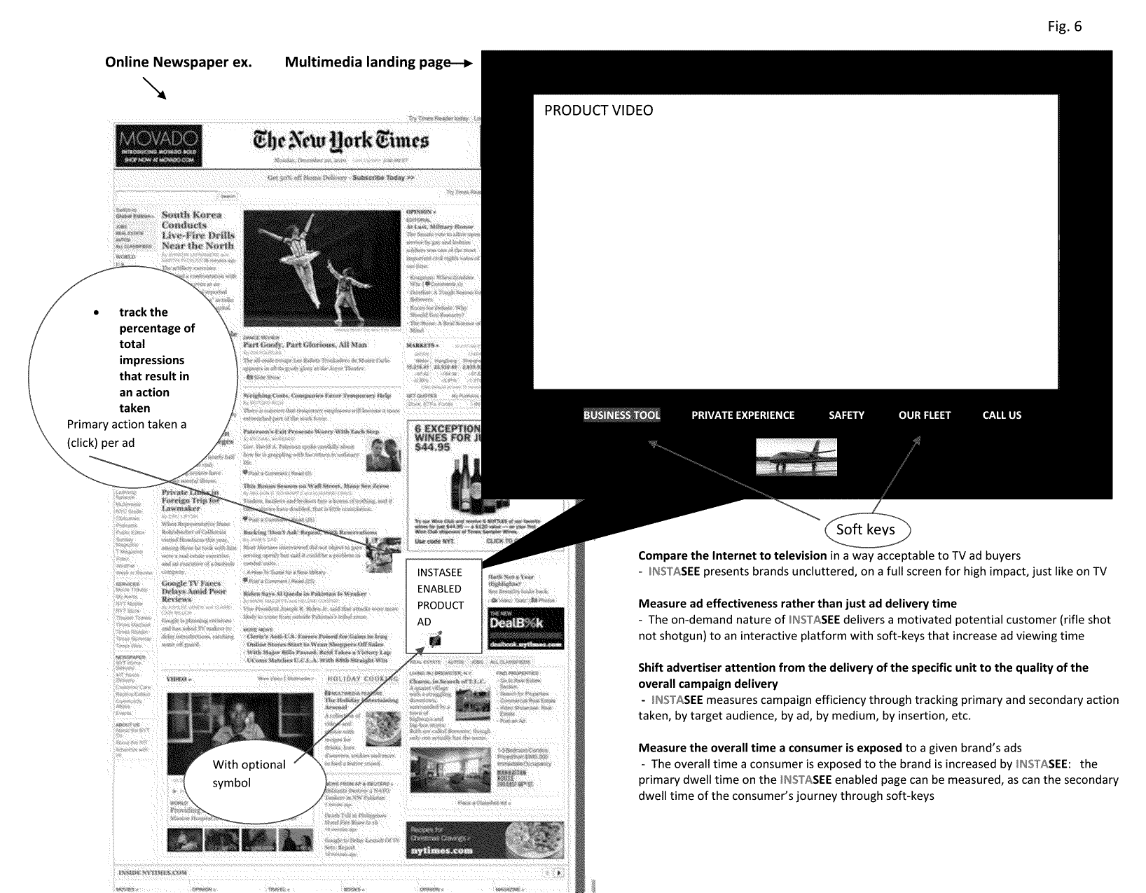

FIGS. 6-27 relate to a simulated fictitious advertising campaign using software of the present invention using fictitious data. Note that various non-limiting embodiments of the present invention, especially a software embodiment, may be referred to herein as “INSTASEE”.

FIG. 6 shows an enabled product ad of the present invention positioned in an online newspaper, with the linked landing page shown inset. The enabled ads of the present invention are On-Demand ads and can (as an option) carry a small symbol to be found quickly by consumers while scrolling on the internet. This symbol tells consumers that the video they are about to see is: “What they want to know and only what they want to know” about the product advertised they are interested in. This symbol can also be used with off-line media.

When an online ad of the present invention is clicked on, the landing page is accessed. The multimedia or videos may be presented to consumers, full screen, eliminating clutter, in an effort to produce a brand narrative that connects with the advertisers targeted consumer and offer the best possible viewing experience, the best personal experience with great content.

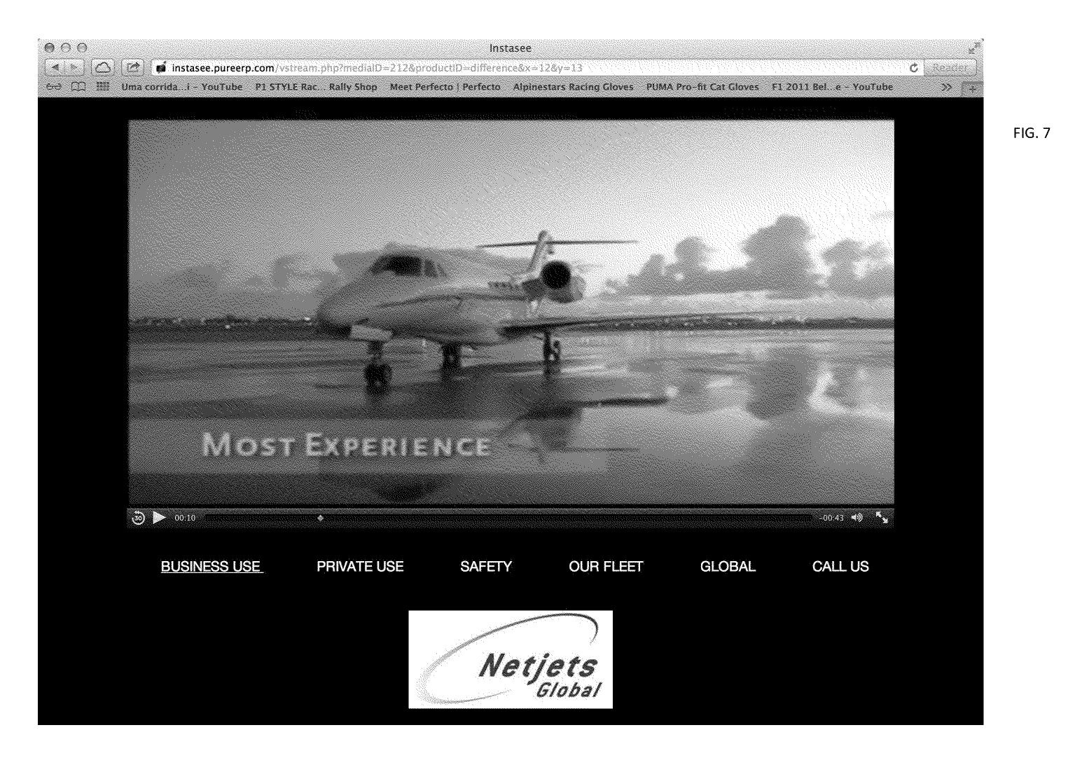

Referring now to FIG. 7 the is shown another example landing page for an online ad of the present invention. The page may be designed to give advertisers unique insight into how users engage with each individual soft key or video in response to particular ads. Precise measurements in <<consumer-seconds>> of each video view and total time spent in front of the brand provide a better evaluation of the effectiveness of the creative unit. As interactive technologies evolve so will the landing page. Videos delivered can be accessed by consumers from all computers and most mobiles and tablets for maximum audience tracking and measurement reach.

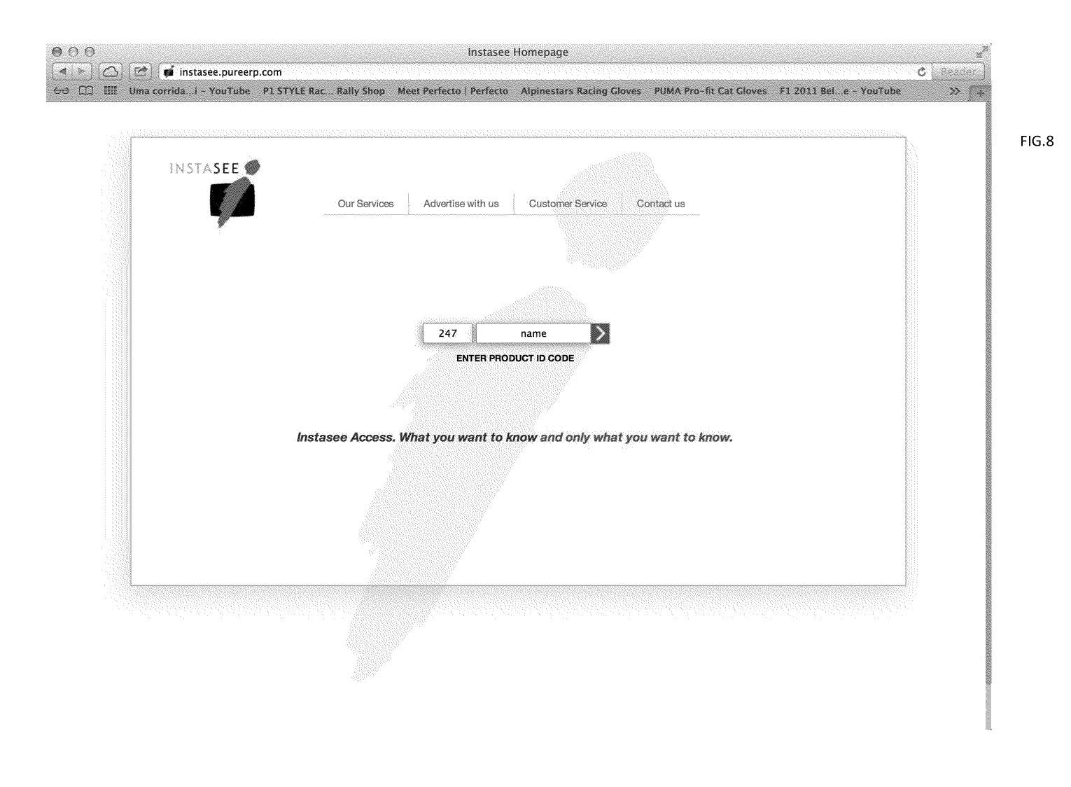

Referring now to FIG. 8, there is a shown a non-limiting example of a Home Page (screen shot). This Home Page is designed for use by consumers and advertisers. On this page, Consumers will find the —Enter product ID code field—in the center of the page, for them to enter the product ID code and click enter to receive the full screen interactive multimedia.

Offline advertising linked to this page may carry an instruction for consumers to follow. For example, “To watch the video, simply enter the product code 247 Yacht Master @ instasee.com.” Note that for advertisers who so choose, the enter code field can be installed in the advertisers' website and consumers can be sent to that advertiser's webpage. QR codes can also be used with the present invention software and the system retrieves and plays an information video of the advertised product. There is no need for consumers to enter a code on the internet, they simply click on the ad or the link.

On this page, Advertisers will find: —“Our service”, reveals text describing company services. Advertise with us, reveals text on advertising benefits. Customer service is for administration and clients to log in: user ID and password window for existing clients and administration. —Contact us—E-mail: for any required support.

The following relates to software implementing one non-limiting embodiment of the present invention. A fictitious advertising campaign will be discussed using this software and fictitious data. An advertiser would use this program as follows:

1. Log in—Go to Home page—Click Costumer service field—Login panel —Enter user name and password

2. Menu—Selections from menu are: campaigns, metrics, clients, account, users, logout.

A) Select from menu “Campaigns”. Existing Campaigns are listed complete with media names and codes used. the following options: +New, View media, Add Media, Update, Remove. (are accessed by clicking on the small symbols in the right margin.)

New—(click top right) is designed to create a new campaign. First, select a client, then enter the information in the proper fields: the campaign name, the product name, enter the campaign's starting date and ending date.

Second, simply enter each media, starting with media category by selecting Print, Internet, TV, Radio, Outdoor, In-store, Products, Other, then add the media type, for example, magazine, newspapers, internet TV, social network direct mail, posters, etc.

Enter the media name, (or download from pre-existing media lists) enter issue number, week or month. Repeat for each individual media. Third, create soft key titles and upload the video or the still image through your browser. Repeat for each additional soft key and video. Fourth, website links, URL's and names are entered. Add advertiser logo from browser.

Preview—the complete landing page as consumers will see it. Submit—Receive auto confirmation. The campaign will run for the period indicated by start and end date.

View media—Enables review of the complete media list where each individual media has been given a code number automatically. Ability to edit/delete individual media. User may print the final list and send the product ID codes were needed for production.

Add Media—Enables a user to add media anytime, even while the campaign is running.

Update—Enables a user to change, remove or add any video, image, soft key titles, websites and links while the campaign is running, including changing the campaign end date. If the campaign has not started, a user can edit and implement all the changes desired.

Remove—Deletes the complete campaign from the list.

When user selection is complete with final media selection, as an “option” additional information can be added to the list for more in-depth data: Circulation, reach, demographics, geographic and time assumption information.

The overall time a consumer is exposed to the brand is increased by the + time assumption feature: time reading or viewing an ad in any medium (the original source of the inquiry) can be assumed and added to the actual “viewing time measurement.

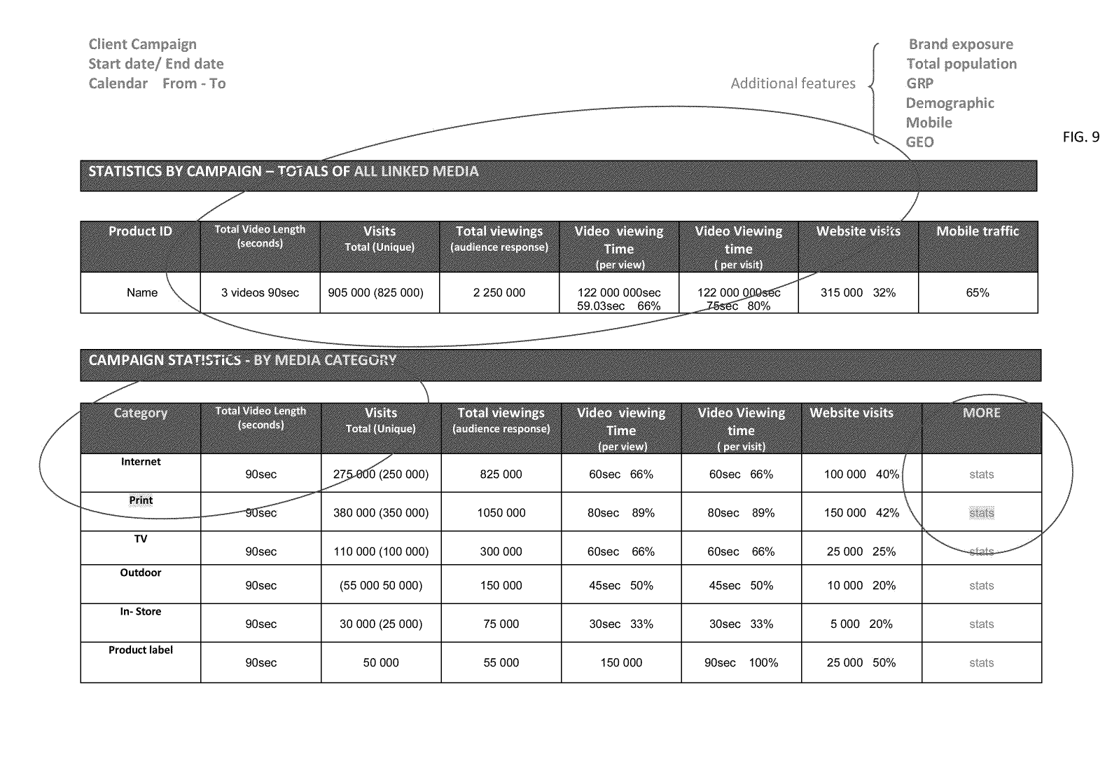

FIGS. 9-27 relate to output generated from the software for the fictitious advertising campaign.

Referring now to FIG. 9 there is shown output generated from the software showing statistics by campaign—total of all linked media and media category.

B) Select from menu “Metrics” (FIG. 9—MetricTable)
Top left, a drop panel lists clients, a second drop panel lists running campaigns: Select client, select campaign. The selected campaign's appears with start date/end date. Campaign calendar: From—To.—advertisers enter any desired period they wish to examine, a specific day, week, weekend or month and all data shown corresponds to the selected dates. The top panel, shows the campaign's performance by total of all linked media. The bottom panel shows campaign performance by media category. Result measurements are displayed in rows for quick comparisons.

Here is a description of the measurements used throughout the metrics.

Product ID—is the name of the advertised product—and is part of the code the system tracks.

Total video length—is each video's duration time, in seconds—that has been uploaded for a campaign, is measured and totaled up. These measurements are used to reference actual video viewing time per video (a view) and per person (a visit)

Visits (total and unique)—Identify target audience. Visits are actual viewings, (total) is how many people that actually saw the ad, and (unique) are the IP addresses the inquiries came from. This metric shows the number of interested consumers in the brand. This has great value for advertisers it's not an impression As an added value, this number can be considered as sales “leads” and can be used for ROI calculations.

Total viewings (audience response)—Is the degree of viewing interaction. How many videos were viewed? Consumers may be invited to watch multiple videos in a visit. This metric also gives insight into audience response to the creative unit. If three videos are offered and a large percentage of the audience only watches the first one, the metric shows instantly there's a problem. With the creative unit.

Video viewing Time (per view)—Suggests the correct video length for audience—is the total & average video viewing time in seconds (per video). Many factors go into deciding what length each video should be: product, demographics, size of screen, etc. This metric gives additional insight into: is the audience responding the way intended by the creative design of the unit and the way the message was thought out. Are they watching all videos. If the presented videos are 3-30 seconds, and the audience watches for a total of 40 seconds again this metric shows instantly a problem with the creative unit and gives a detailed video viewing time measurement per video, where audience viewing patterns can be observed.

Video viewing time (per visit)—is consumer Brand exposure time—Is the total & average video viewing time per person. Focuses on engagement, the quality of the creative unit and answers the question is the message getting through? The greater the percentage, the more brand awareness, recall, desire and sales increase.

Visits to website—Confirms audience response to a call to action—Refers to the client's website and the relevant product page viewers went to: the call to action could be for a purchase online, print a rebate coupon, register, vote, sign-in all measurable, that further provides answers to is the advertising working.

Mobile Traffic—is the percentage of visits coming from either smart-phones and tablets.

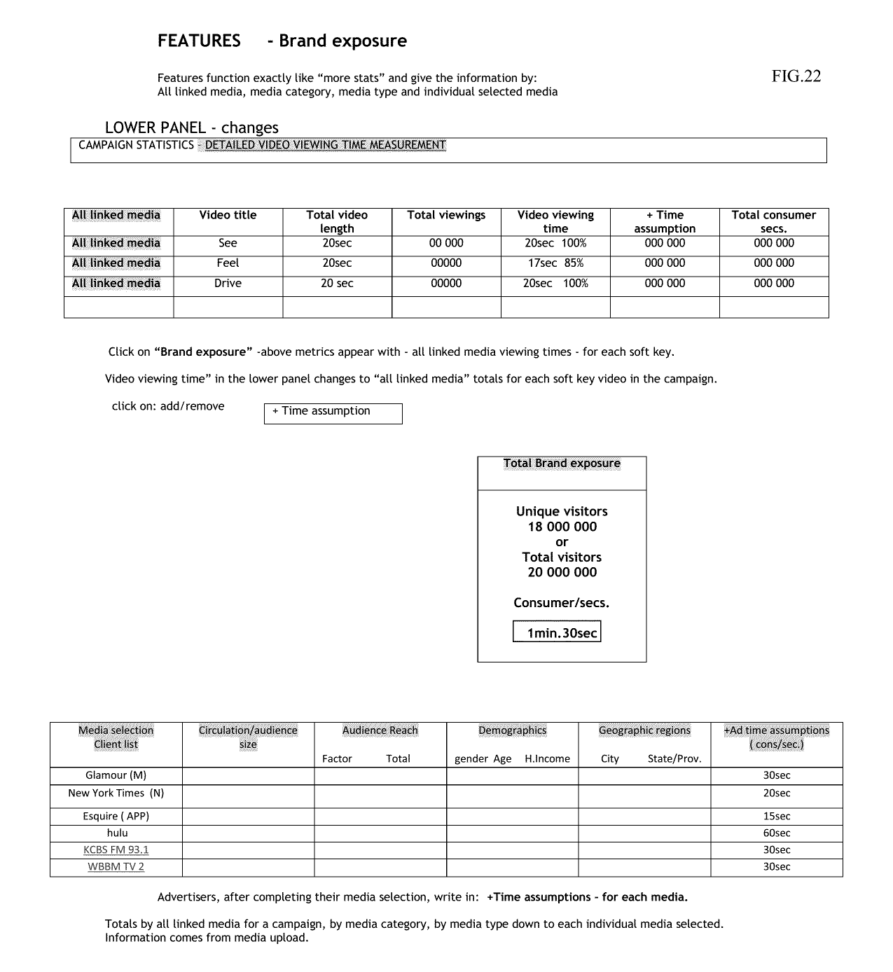

Additional Features—will be described further in FIGS. 22-25.

This table of FIG. 9 is to be used primarily by SVP'S, CEO'S, those who are responsible for brands, those who need to know quickly if the message is getting through and if the advertising is working? They readily can know this by looking at the top panel, and observe in real time—how many people have viewed how many videos, for how long, and how many people went to the designated website page. The numbers displayed are actual and intuitive. One can react immediately to precise results that are based on actual consumer responses with exact times spent in seconds by a person in front of the brand, and say yes, the campaign is going very well. This is what time based measurement will do. It enables advertisers to link “consumer viewing time” to increases in sales and in future advertising campaigns could be charged by seconds of brand exposure for a given target audience.

The bottom panel shows the data broken down by the media categories purchased for the campaign: Print, TV, Internet, Outdoor, In-store, etc. (left column). Again performances results, row by row, can be compared and significant observations can be made very quickly. This data is helpful for “Share Shift” calculations: which is what happens to reach, and GRP's of a campaign if for example, X % of the dollars is moved from TV to the Internet or from Internet to print?

“More stats” is a very simple device (right column, row by row) to use in order to navigate through the metrics' tables. Click on “more stats” to access the time based data for each media category, each media type, each individual media by title or name, each video, geographic information (where the inquiries came from) for analyses. The new data gives insight into consumer actions by audience segment.

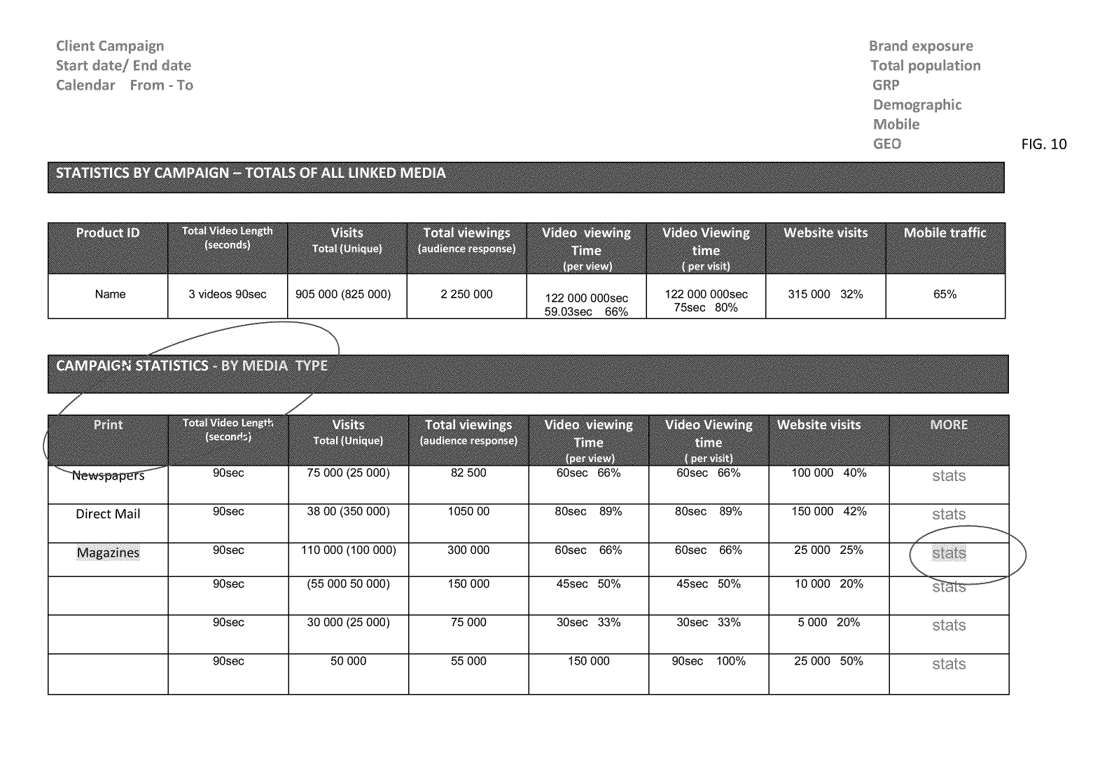

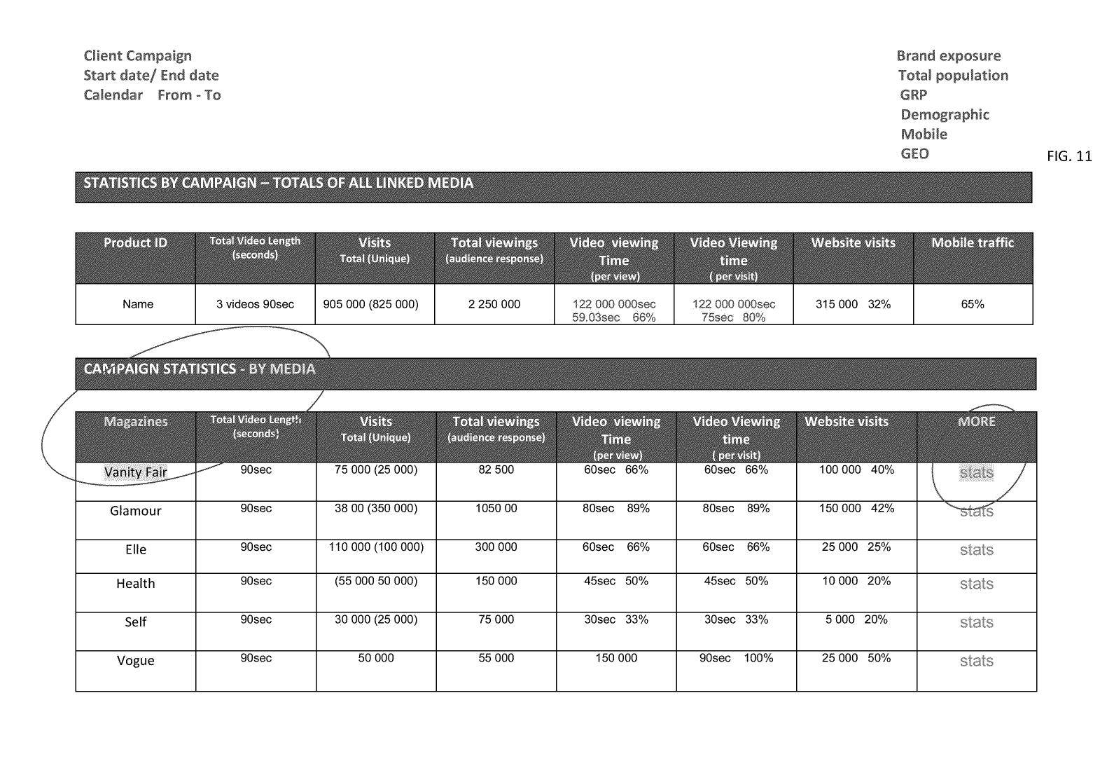

Referring now to FIG. 10, there is shown output generated from the software showing statistics by campaign—media type, and referring also to FIG. 11 there is shown output generated from the software showing statistics by campaign—by individual media.

As an example, select “more stats” Print, and move from” Print media category “to “Print media type”, and table 2 appears (FIG. 10). From this point on the information will bring clarity to those responsible for media planning and marketing. The left column shows your Print expenditure: magazines, newspapers, direct mail for performance data and comparisons. How many visits?, for how long?, how many visits to website? To further analyze the best performing media within each media type, as an example, we select “more stats”-Magazines- and table 3 appears (FIG. 11) with all selected magazines listed by title, with their performance data ready for comparison.

With this much information, media buyers who are very much in the dark now have solid data and measurement to support judicious media purchasing decisions and costs efficiency.

For further analysis, select and analyze the individual media and specific title:

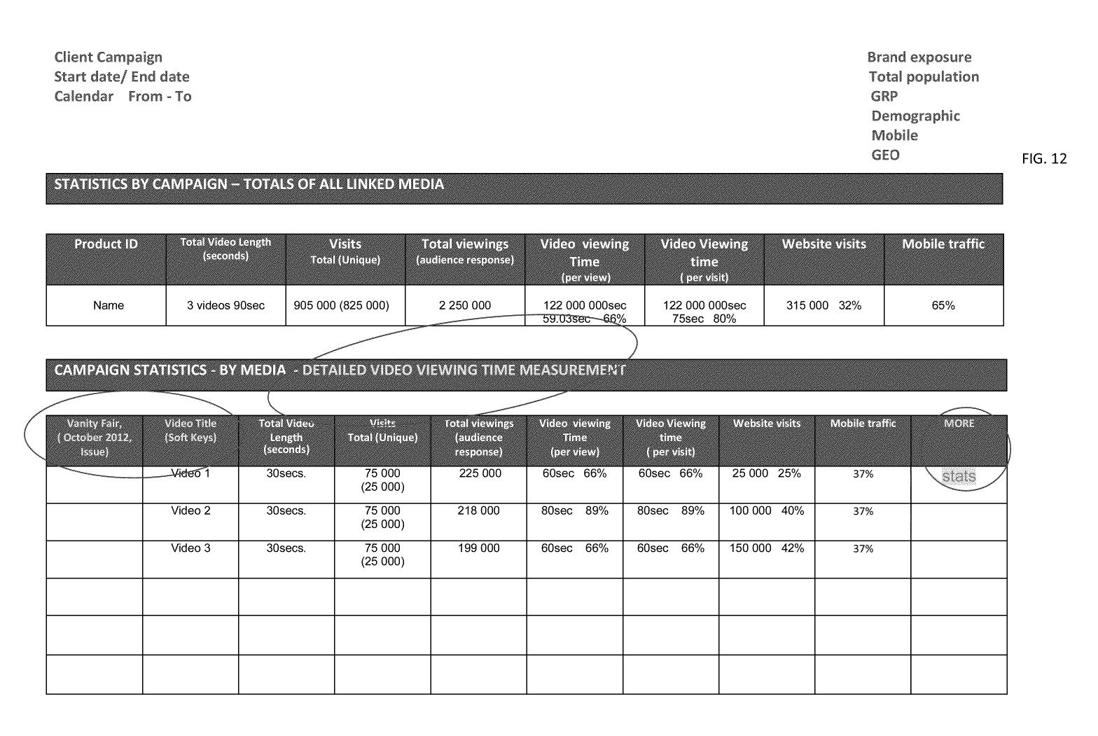

Referring now to FIG. 12, there is provided output generated from the software showing statistics by campaign—by detailed video viewing time measurement.

“more stats —” Vanity Fair—is selected, table 4 appears. (FIG. 12)—by detailed video viewing time measurement. The left column shows Vanity Fair and which issue. This table shows each video and soft key title (second column from the left), the length of each video in seconds, (third column from the left), how many viewings of each video and viewing time in seconds. This information is valuable to the creative team. It can now observe how users journey through the soft keys and videos. Examine how audiences interact with each soft key in the brands ‘creative unit:

Are they watching all videos? Are they skipping some? Is there a pattern that can be observed: The audiences using smart phones show shorter viewing times then other viewers. The average “Video view time” is only 20% of the total length as opposed to 60% for PC users. In this example, it may be necessary to shorten video lengths for mobiles. These answers and many more contribute to further refinement of the message and greater efficiency of communicating with a specific audience anywhere. And, these changes can be done, for the first time, while the campaign is running.

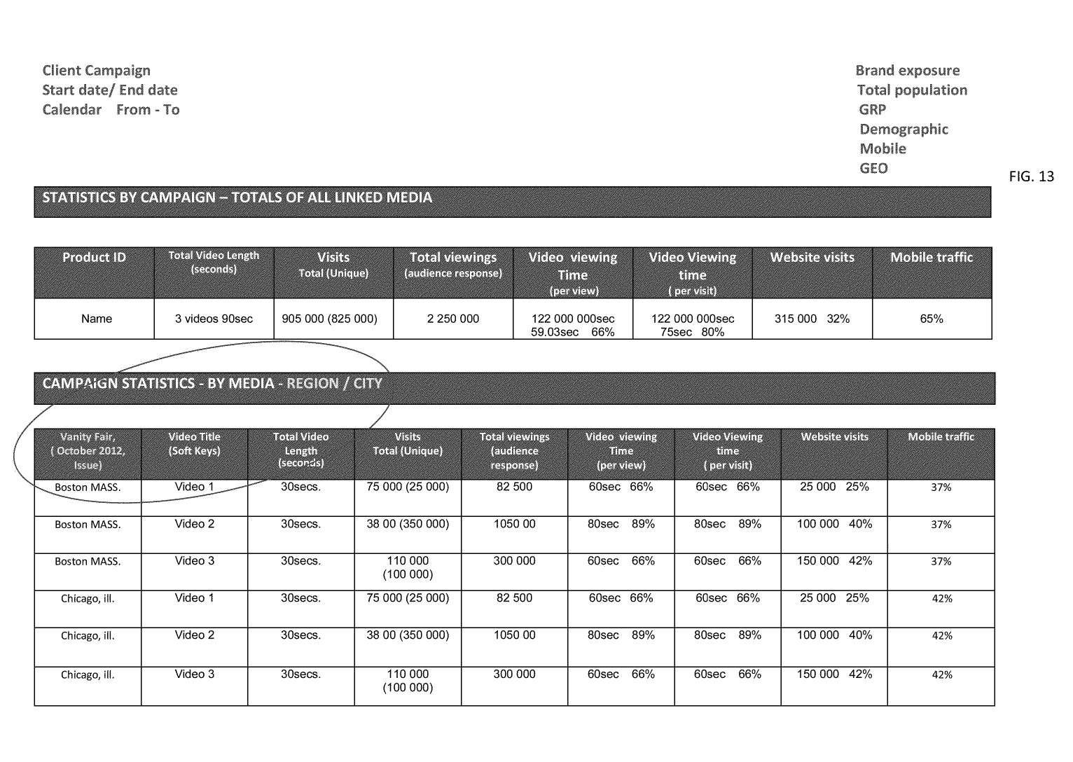

Referring now to FIG. 13, there is shown output generated from the software showing statistics by campaign—by Region/City.

Selecting “more stats” again will bring geographic information. Table 5. (FIG. 13) The location from where each inquiry or visit came from is conveniently listed. This information is important to media buyers to determine which media are penetrating the market best, where, to the creative team, which message plays best where, and to marketers, identify where their biggest markets are and which ones need immediate attention.

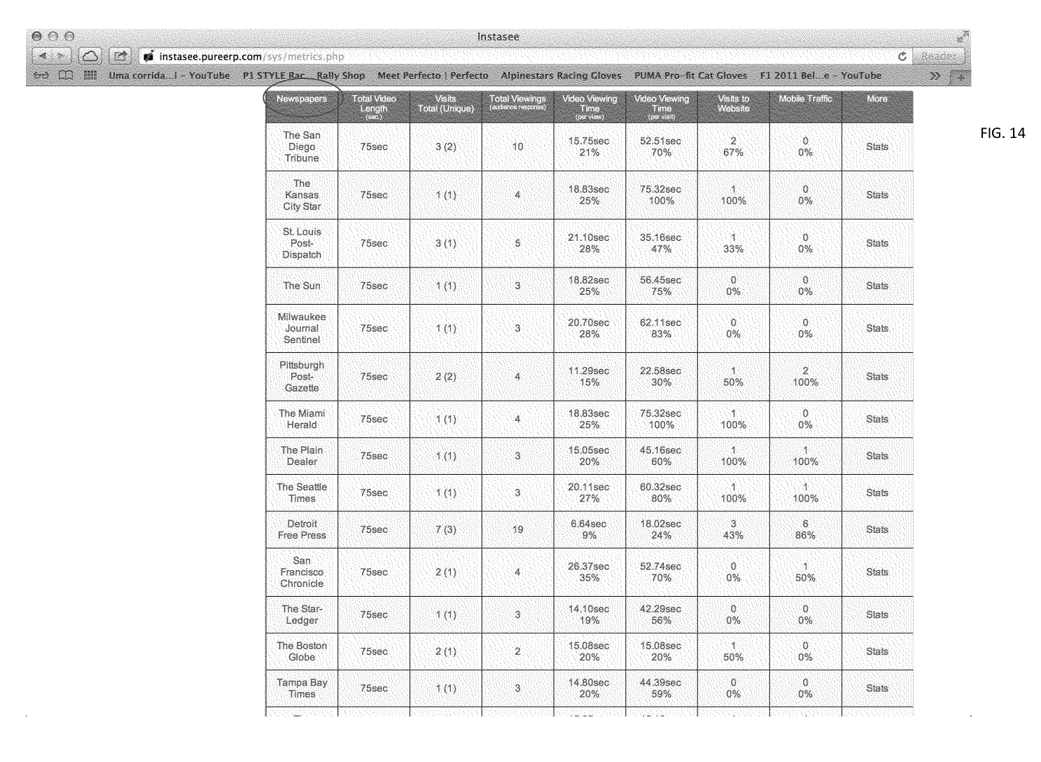

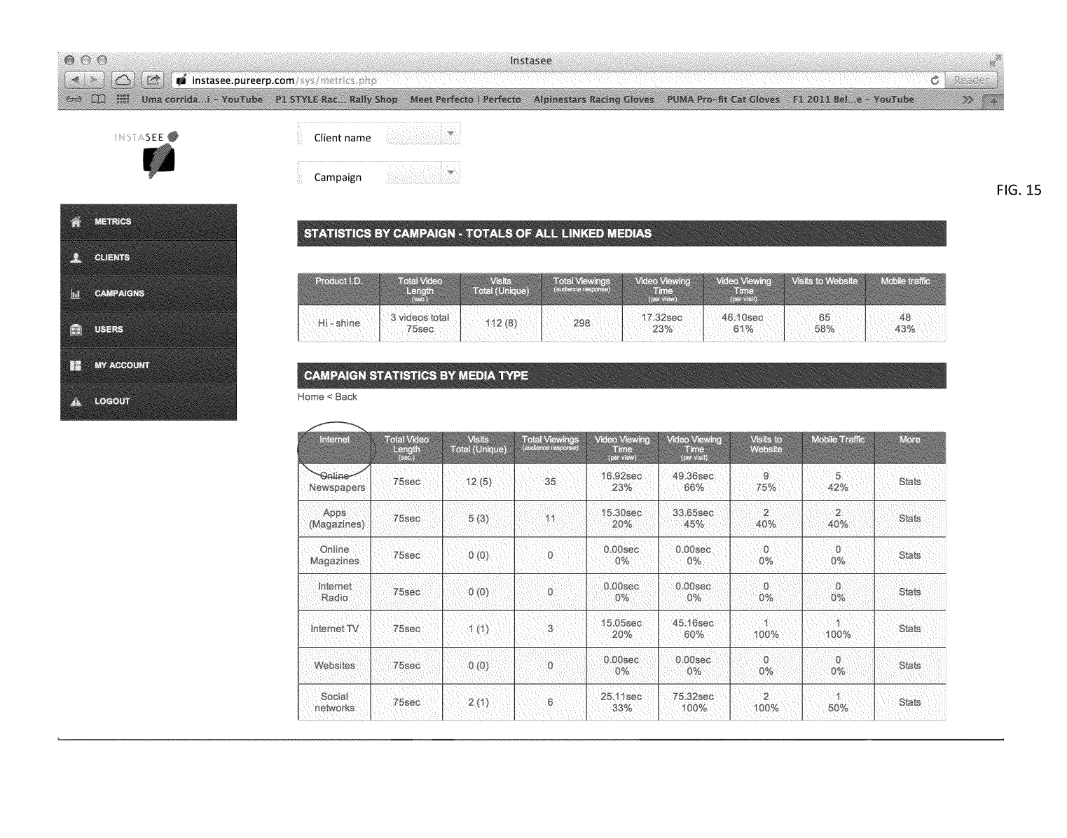

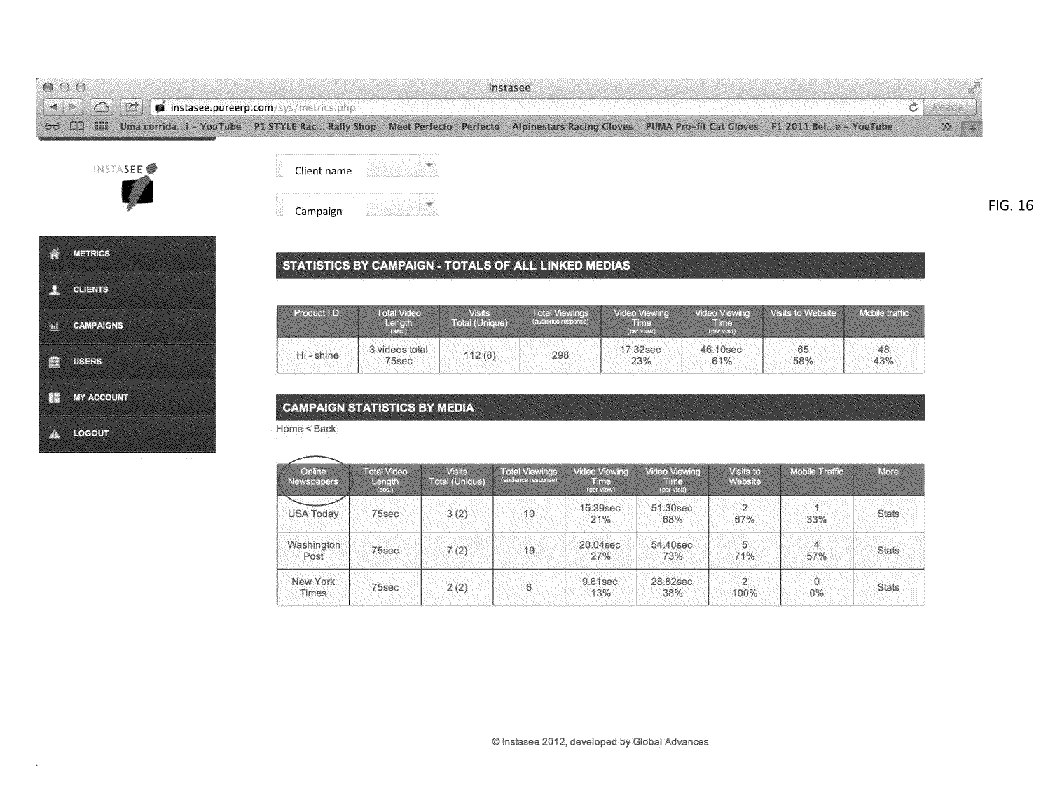

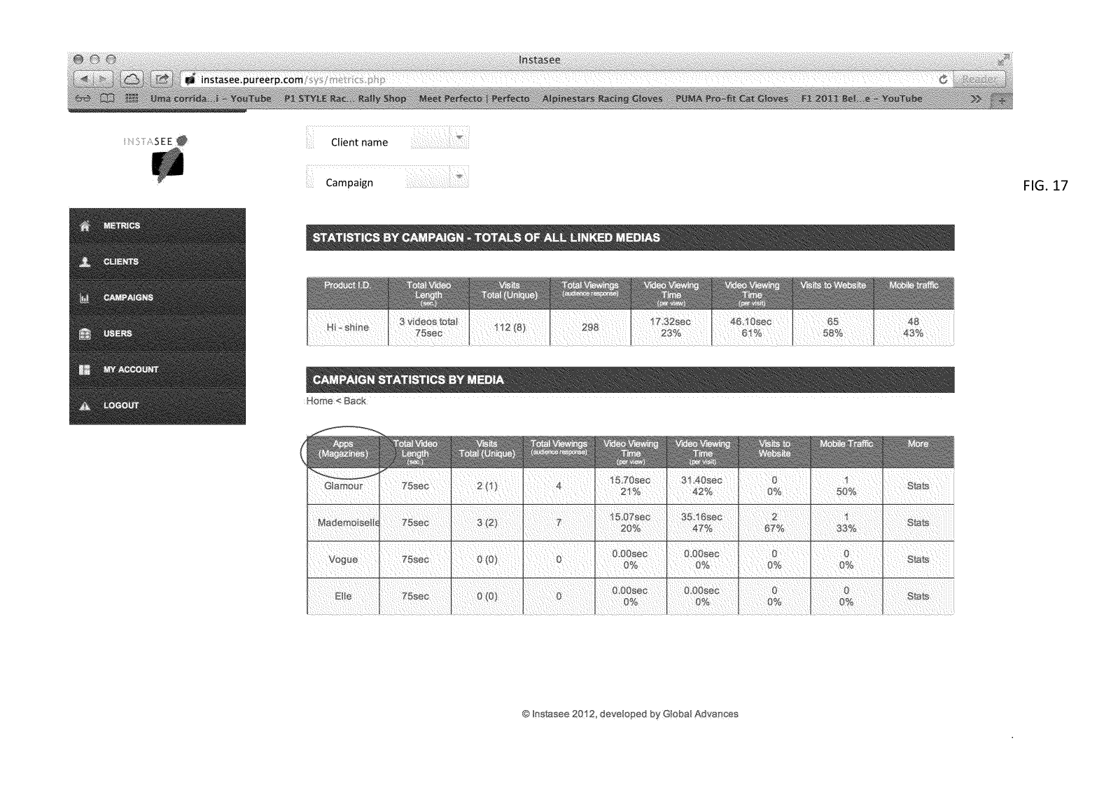

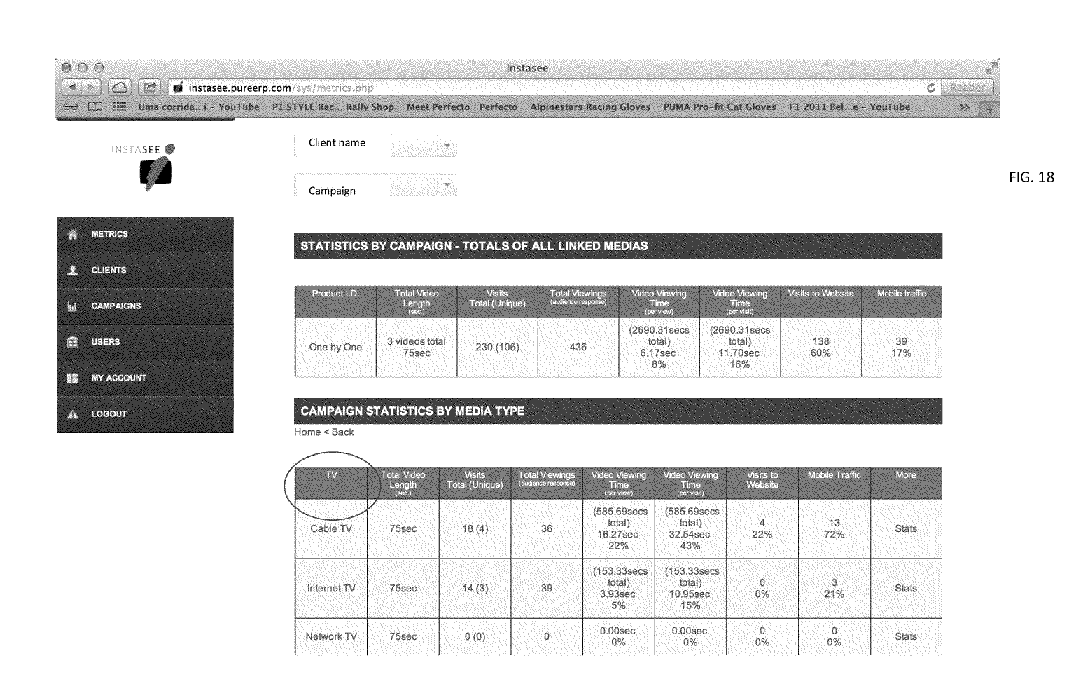

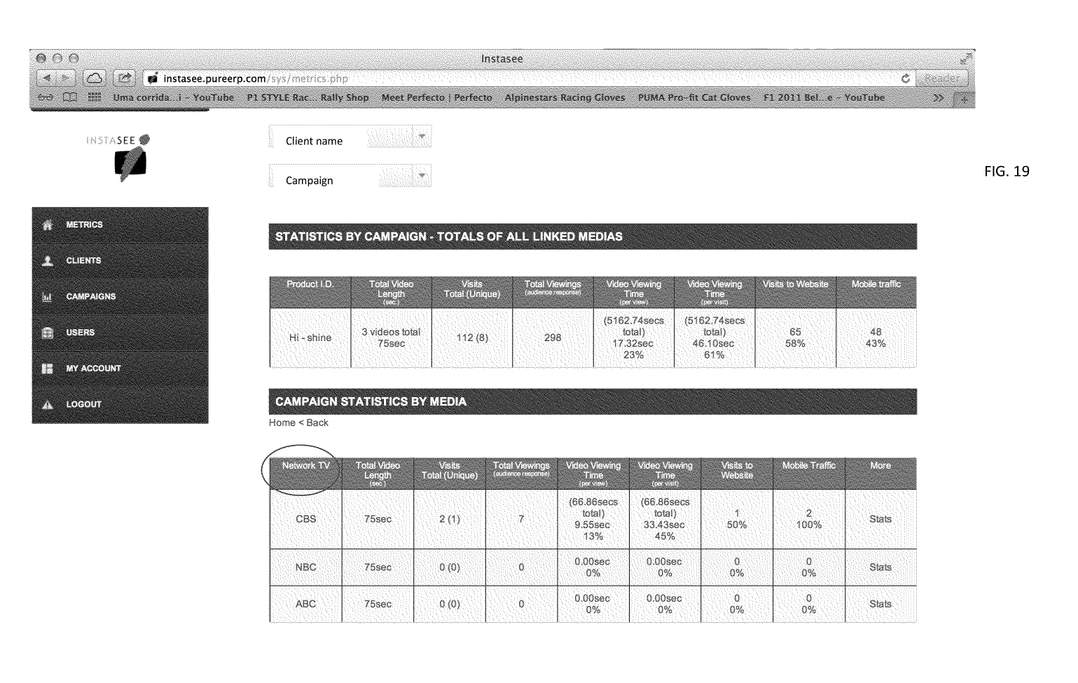

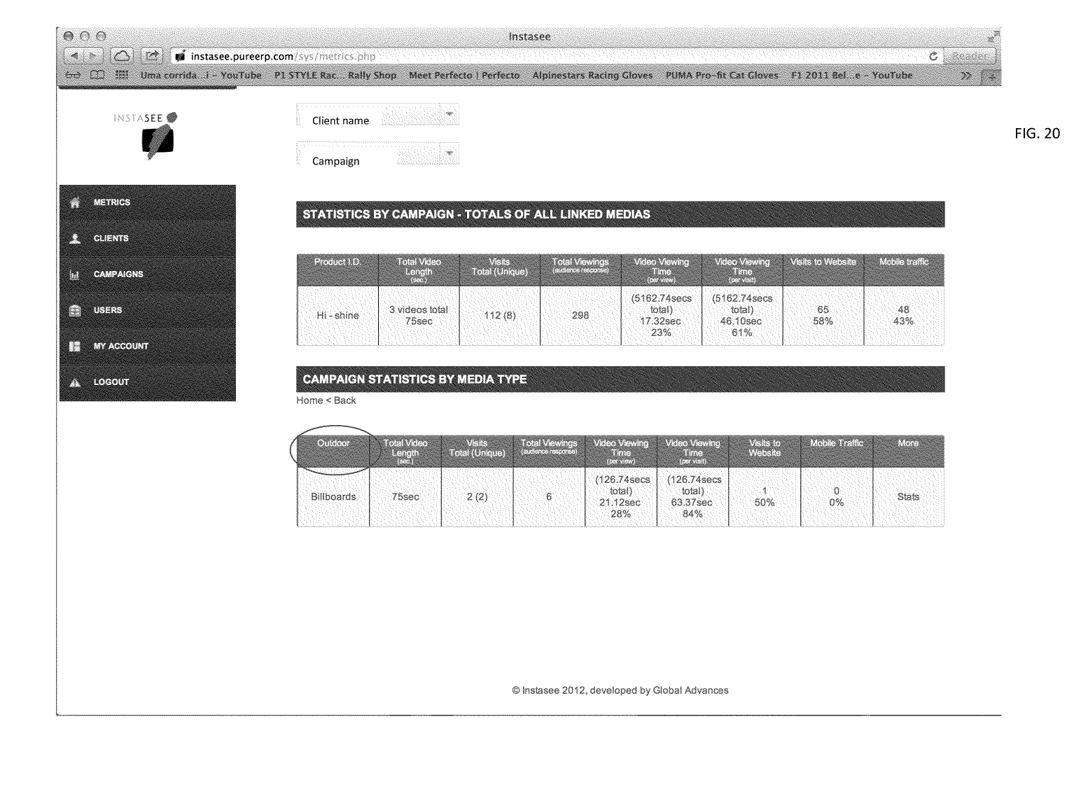

Referring now to FIGS. 14-20, there is shown output generated from the software showing statistics by campaign—Newspapers (FIG. 14), Internet (FIG. 15), Online newspapers (FIG. 16), Magazine APP's (FIG. 17), TV (FIG. 18), Network TV (FIG. 19), and all media (FIG. 20).

For more information, simply repeat the process for all and each media: 1) Category 2) Type 3) Individual media. Simply ask for “More stats”. The example software tracks and measures all media, for examples, see, FIGS. 14-20.

The immediate “mass audience feedback” provided, with exact consumer actions and engagement measurement, enables advertisers to react in time, an move faster to refine their marketing strategy, creative strategy, message and concepts to deliver with more precision a more efficient and quality ad unit.

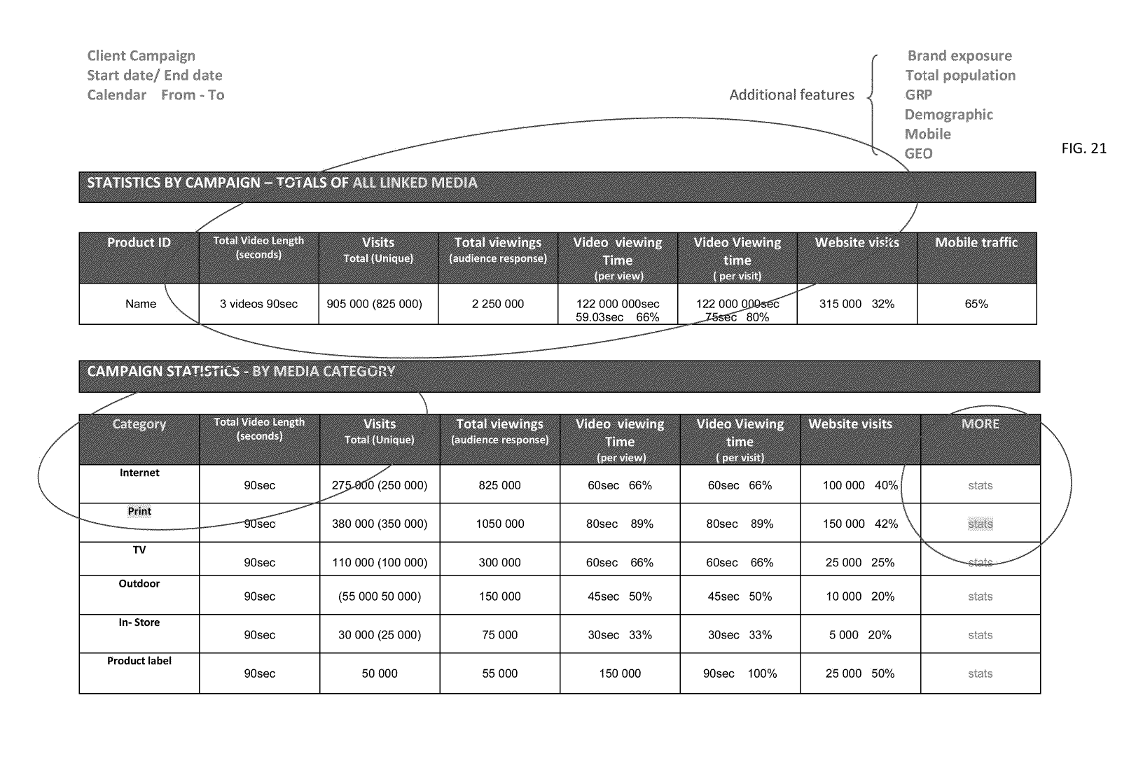

Referring now to FIG. 21, there is shown output generated from the software showing statistics by campaign, with Additional Features shown at top right. To access these additional features, a user would just clink on the desired function.

Referring now to FIG. 22 there is shown additional features of the software—brand exposure. Brand exposure—is the added “Time assumption” feature that helps give a more precise measure of Brand exposure time: If a consumer product inquiry comes from a specific magazine, one can assume that the consumer read the printed ad in the magazine first. The time it took for him to read this ad is added to the video brand exposure time; if on the other hand the inquiry came from a TV ad, the 15 sec, 30 or 60 sec it took to view this ad is also added. These assumptions are added for each media linked to software embodiment. Here's how it works: 1. The overall time a consumer is exposed to the brand (video1) is increased by the consumer's journey through soft-keys (other videos). 2. time reading or viewing an ad in any medium (the ad that provoked the inquiry) can be assumed an should be measured.
SOURCE ADS TIME ASSUMPTIONS+VIDEO VIEWING TIMES=TOTAL BRAND EXPOSURE IN CONSUMER-SECONDS.

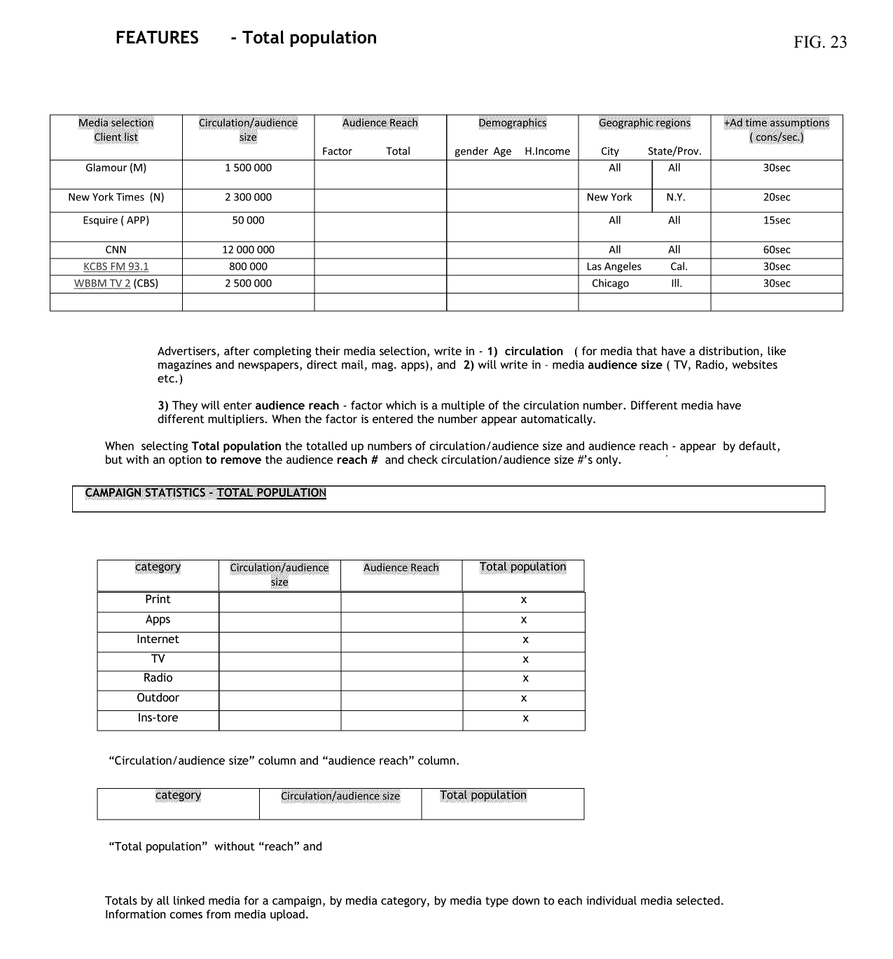

Referring now to FIG. 23, there is shown additional features of the software—Total population. When selecting Total population the totaled up numbers of circulation/audience size and audience reach from each media—appear by default, but with an option to remove the audience reach and look at circulation/audience size data only. GRP performance numbers can also be used with and without reach. Some advertisers use reach, some do not.

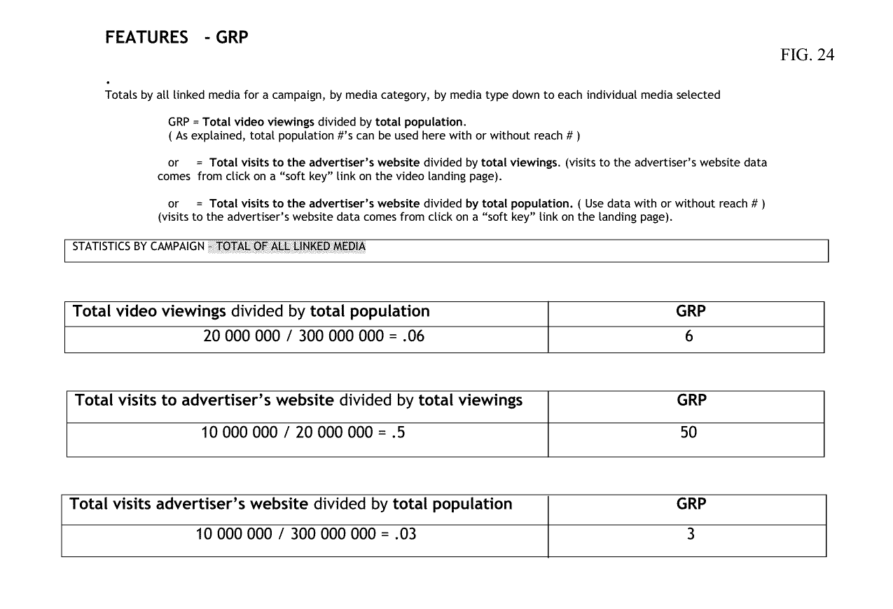

Referring now to FIG. 24, there is shown additional features of the software—Online GRP wherein,
GRP=Total video viewings divided by total population.
(As explained, total population #'s can be used here with or without reach #) or =Total visits to the advertiser's website divided by total viewings. (visits to the advertiser's website data comes from click on a “soft key” link on our video landing page).
or =Total visits to the advertiser's website divided by total population. (as explained provide the ability to use data with or without reach #).

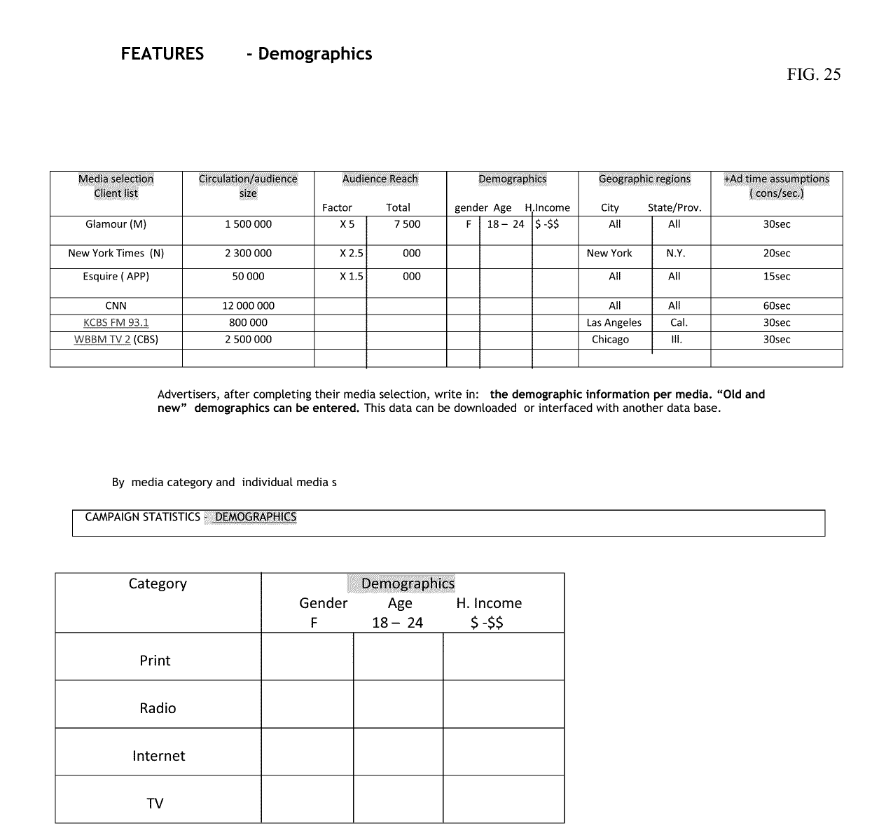

Referring now to FIG. 25, there is shown additional features of the software—Demographics.

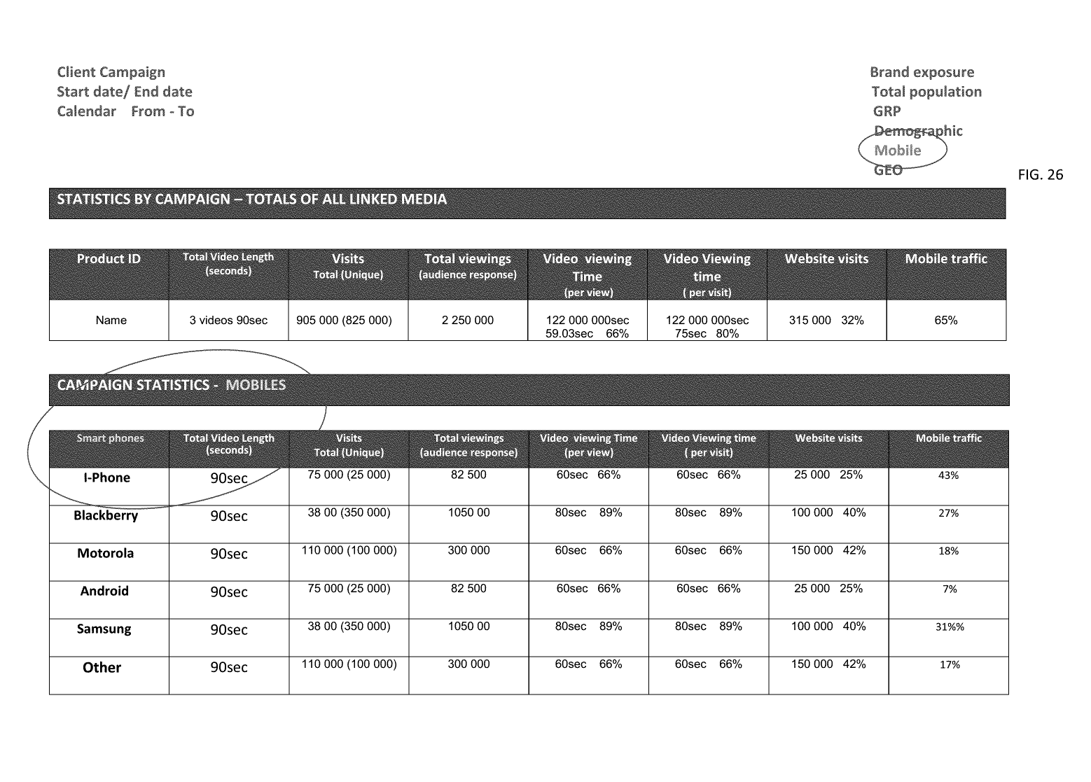

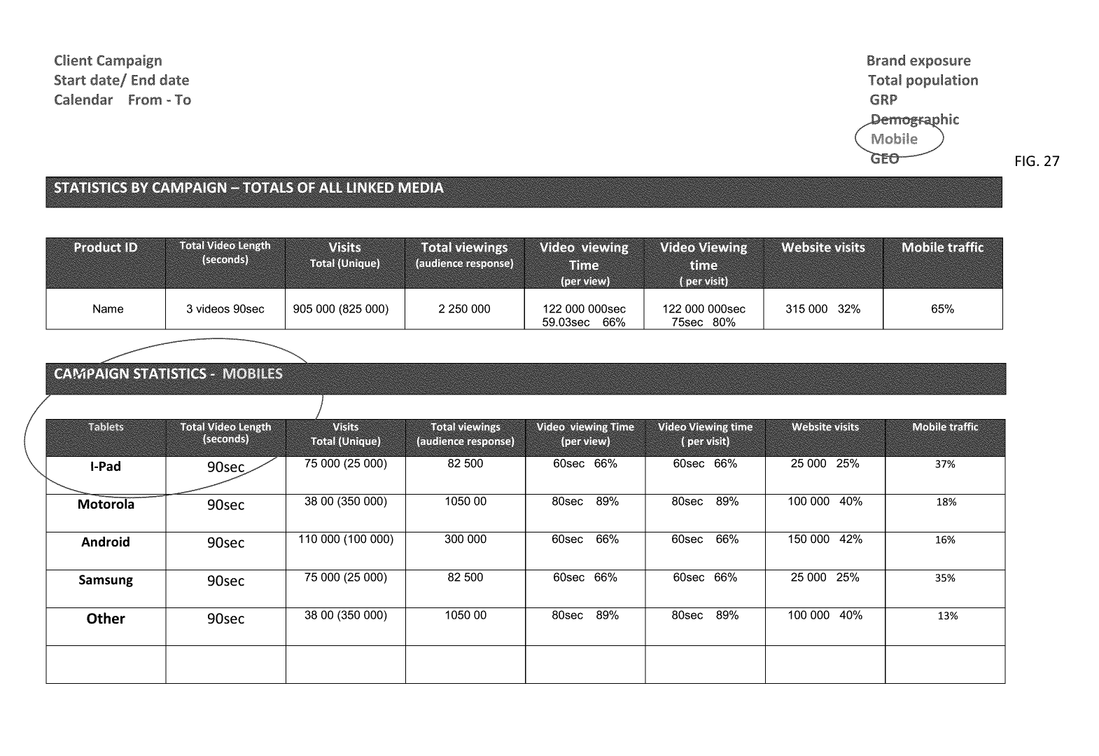

Referring now to FIGS. 26 and 27, there is shown output generated from the software showing statistics by campaign—mobile devices—smart phones (FIG. 26), and tablets (FIG. 27). When a mobile user makes an inquiry, the smart phone or tablet used is listed for segment audience analysis. Demographic information can be extrapolated: a Blackberry user doesn't have the same profile as an Apple user, as an example.

GEO—by all linked media for a campaign, by media category, by media type down to each individual media selected. Additional geographic location details grouped by State, City, region. Individual IP address list can be accessed and retrieved.

Only Time Based Measurement can provide the solution to advertisers' needs. The methods, apparatus and products of the present invention provide the metrics that are relevant and scientifically based in the advertising business for all to understand: seconds of exposure, all media sources in one place, with the ability to make “apples—to—apples” media comparisons, solid and precise measurements and feedback for a more targeted “message” and quality creative unit.

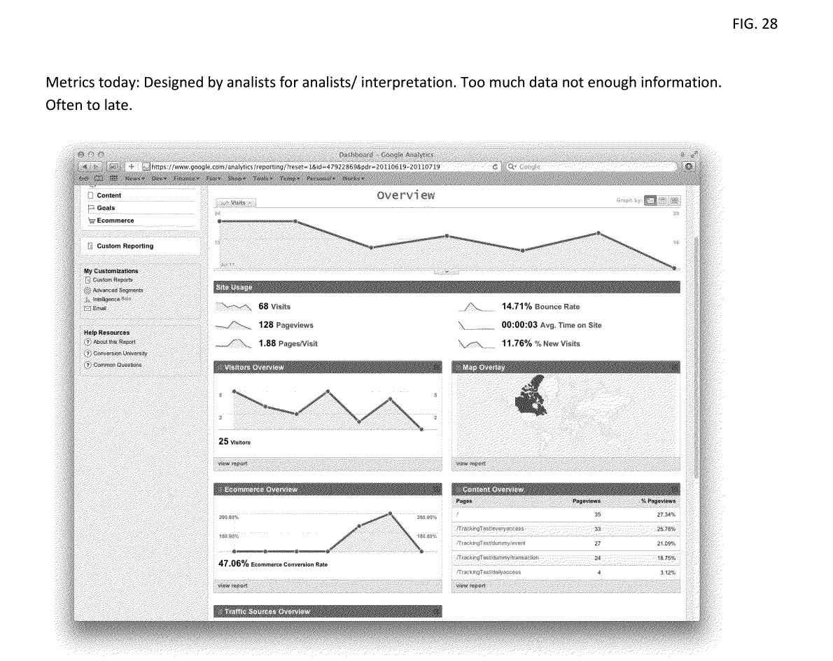

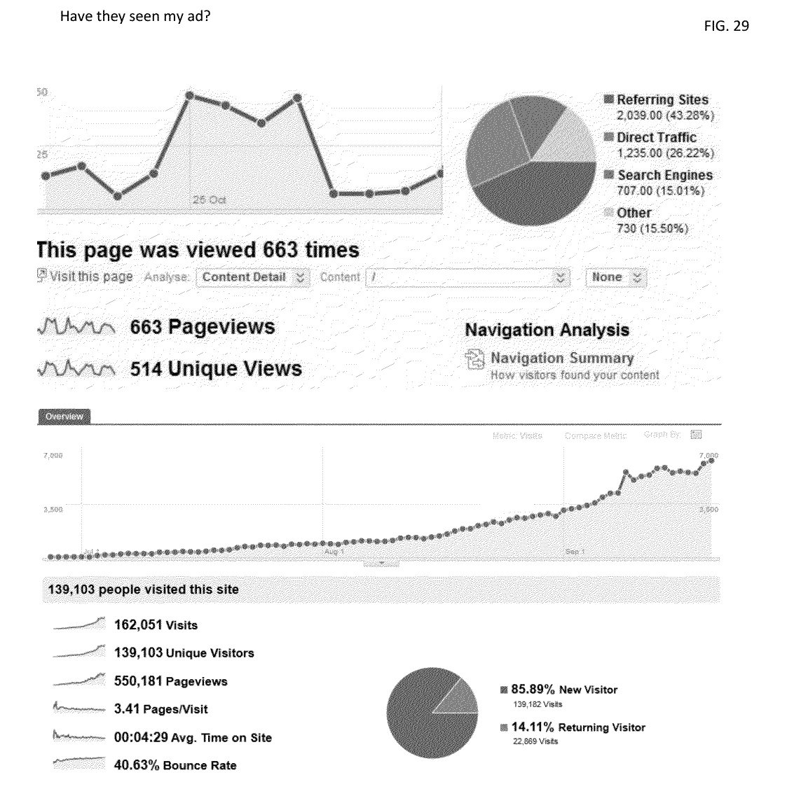

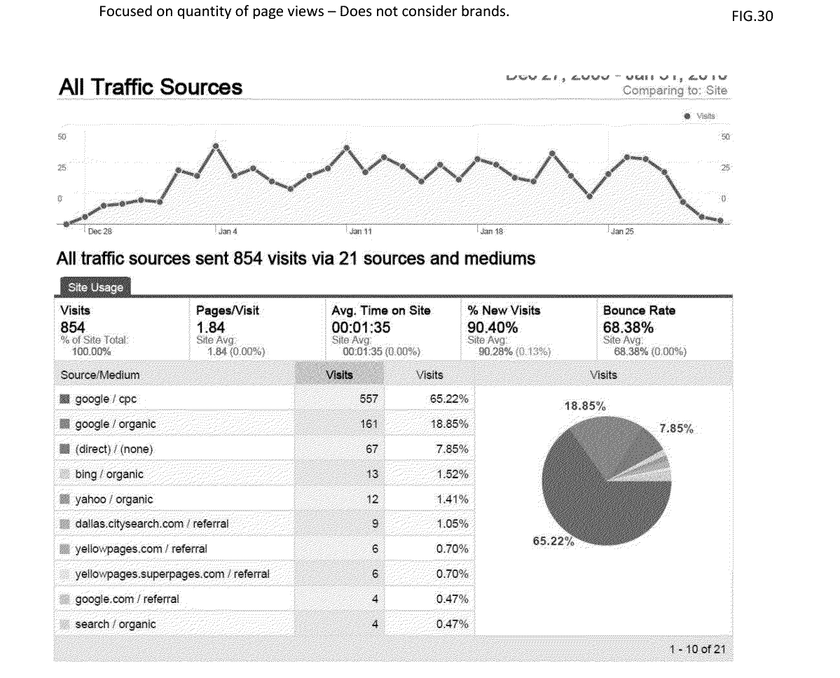

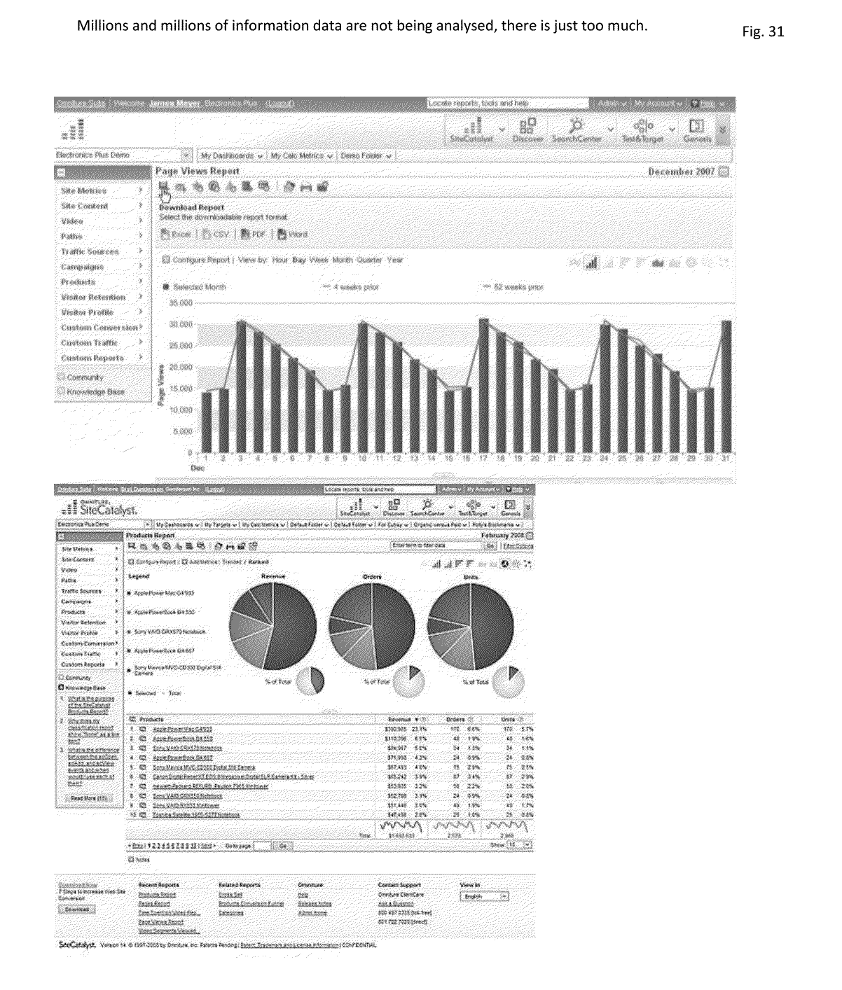

As a contract, FIGS. 28-31 provide examples of output from prior art advertising metric systems. In particular, these other metrics systems follow IAB guidelines and data are still based on impressions. IAB and Analytics companies are now moving toward a new and improved “viewable” impression, it's still an impression and will only improve slightly the “opportunity to see” an ad. They cannot tell if an ad is being viewed and for how long.

C) Further under “Select clients”—this is for the software administration access (only).
“Create new client”—Enter client name, contact person, phone, e-mail, Address, update, remove. —Select—clients”, see a list of all clients.
Advertisers (clients) administration access.
“Create new client”—Enter client name, contact person, phone, e-mail, address, update, remove. —Select—clients”, see a list of all clients.

In this non-limiting example, the software “administration” sets up accounts, clients, and users, has access and monitors all client and campaign activities and can activate or deactivate any campaign or customer. The software users/customers have similar administrative access: set up accounts, clients, users, for their internal controls, but administrative access is limited to their own clients and brands.

A users may stop a campaign at any time, including while the campaign is running. If a campaign is stopped, a polite text message to consumers appears on the “landing page”. If the Campaign is stopped by the software administrator (for example, for budget reasons or other control reasons) the message appears automatically. If the campaign is stopped by the user/client, that user/client has the option of writing its own message. It is anticipated that the software may include a “stop campaign” and write campaign cancellation message window.

If a campaign now has to be deactivated:

Option 1. Client goes to Menu—clicks on “Clients”, selects existing clients, selects Client, selects Campaign—(shows “Active”)—clicks to de-activate (shows inactive)

Option 2. Client sends an e-mail to the administrator with a request that it wants to stop a specific campaign. —Automatic e-mail is returned by administration to sender with a link to a form that must be filled in and sent. Administration receives info from client with sufficient campaign identifier information to automatically deactivate the specific campaign.

If a campaign is to be reactivated, basically the same process is used. Client sends new email—Campaign identifier information, with new start/end dates . . . etc. to—the software administrator. Client receives confirmation and removes Campaign cancellation message:

Press “remove” message, in stop campaign menu.

Campaign will restart on new set dates.

D) Select user —software administration access (only)
“Create new user”—Enter user name, e-mail, user name, password, company Name, update, and remove. —Select—users”, see a list.
Advertisers (clients) administration access
“Create new user”—Enter user name, e-mail, user name, password, company Name, update, and remove. —Select—users”, see a list.

E) Select account—INSTASEE administration access (only)
Displays current rate card with costs for housing videos/still images and tracking and measurement costs per viewing. Costs are monitored in real time by campaign: account balances, remaining balances, alerts on minimum balance, purchase credits.

Advertisers (clients) administration access
Displays current rate card with costs for housing videos/still images and tracking and measurement costs per viewing. Costs and remaining balances are monitored in real time by campaign.

F) Logout.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

All references cited herein, including articles, U.S. and foreign patents and patent applications, are specifically and entirely incorporated herein by reference.

What is claimed is:

1. A method of online advertising, wherein an online advertisement comprises a link to a dedicated online product landing page, the method comprises;
(A) Receiving a visitor onto the dedicated product landing page who has utilized that link; and,
(B) Measuring the duration between the time the viewer was received on the dedicated product landing page, and when the viewer clicks on a soft key.

2. The method of claim 1, wherein the link provides identifier information, and the method further comprises (C) creating a report utilizing the identifier information.

3. The method of claim 1, further comprising (C) measuring the time between subsequent other soft key clicks” to determine the viewing time of information accessed through the other subsequent soft key.

4. A method of advertising, wherein one or more online advertisements each comprise its own unique link to a dedicated online product landing page, and wherein one or more offline advertisements each comprises it own unique codeword to access the dedicated product landing page, the method comprises;
(A) Receiving a visitor onto the dedicated product landing page who has utilized the unique link or unique codeword; and,
(B) Measuring the duration between the time the viewer was received on the dedicated product landing page, and when the viewer clicks on a soft key.

5. The method of claim 4, wherein the unique links and unique codewords provide identifier information, and the method further comprises (C) creating a report utilizing the identifier information.

6. The method of claim 4, further comprising (C) measuring the time between subsequent other soft key clicks” to determine the viewing time of information accessed through the other subsequent soft key.

7. A method of advertising utilizing an application server, comprising,
(A) receiving at the application server, a video viewing request from a browser serving a user;
(B) playing a video in response to the video viewing request; and,
(C) generating statistical information about the video viewing.
